(19) United States
(12) Patent Application Publication
(10) Pub. No.: US 2006/0280840 A1
(43) Pub. Date: Dec. 14, 2006

(54) Universal protein formulation meeting multiple dietary needs for optimal health and enhancing the human immune system

(76) Inventor: Marion G. Robertson, Virginia Beach, VA (US)

Correspondence Address: GUERRY LEONARD GRUNE, 784 S VILLIER CT., VIRGINIA BEACH, VA, 23452, US

(21) Appl. No.: 11/135,895

(22) Filed: May 24, 2005

(51) Int. Cl. A23L 1/30

(52) U.S. Cl. 426/72

(57) ABSTRACT

The invention includes a protein rich, dry dietary supplement comprising a blend of legume protein, whey protein, egg white, calcium caseinate and powdered skim milk that is specifically formulated for weight control without the use of artificial appetite suppressants, but instead provides beneficial nutrients and supplements that naturally curb the appetite for specified periods of time. A preferred set of ingredients includes a protein blend combined with additional nutrients, vitamins, minerals and flavorings to enhance taste and further control the need for caloric intake. Various other preferred forms of the invention provide for implementation to allow for weight gain or weight maintenance of individuals desirous of the use of the beverage as a dietary supplement for those purposes.

### FIELD OF INVENTION

This invention involves liquids and solids that include legume proteins for nutritional completeness including the use of egg whites as well as soy protein isolate and whey protein concentrate, non-fat dry milk, safflower oil, vitamins, minerals and various additional supplements beneficial for dietary needs and enhancement of the human immune system. The present invention has been designed for controlling hunger associated with excessive or restricted caloric intake by humans, thereby allowing for weight reduction, gain, or moderation while also ensuring complementary supplemental dietary needs to assist in both disease and ill-health related prevention. Various forms of the invention could also be implemented to allow for weight gaining or weight maintenance for individuals desirous of use of a beverage or other food source together with the protein formulation as a dietary supplement for those purposes.

### BACKGROUND OF THE INVENTION

The fattening of America has been referred to as a crisis and an epidemic. A Time Magazine article (Jun. 7, 2004) reported that two-thirds of U.S. adults are officially overweight. The number of obese people in the U.S. has doubled in only the past few years. The U.S. Surgeon General's office estimates that $117 billion is spent each year on obesity linked illnesses, and that poor diet and lack of exercise rank No. 2 behind the use of tobacco as a preventable cause of death. Medical doctors in the United States indicate that approximately 300,000 people die needlessly and prematurely from complications due to obesity each year.

A landmark study conducted at the University of London in England in the 1950s found that patients who were given a 1,000-calorie diet high in fat (90%) lost significant amounts of weight, while the same patients when given a 1,000-calorie diet high in carbohydrates (90%) lost virtually no weight at all. Eating “good fat” does not make you fat; it actually helps your body bum fat more efficiently.

For years, nutritionists have taught that avoiding fat would prevent or at least reduce obesity. Although based on a worthy premise, the American low fat diet turned out to be a dismal failure. Estimates indicate that only about 5% of Americans for whom a low-fat diet is recommended actually stay on it consistently for the long-term.

When compared with a higher fat, more European-style diet, the results of the American low fat diet were very disappointing. The “low-fat” diet was associated with up to 65% more heart attacks and other health related problems.

In retrospect and with objective reasoning, there seems to be many factors regarding the fact that the low-fat diets failed. Most people missed the flavor and texture of the fat. They traded this for the sensuous pleasure of simple sugars. Sweet foods greatly whet the appetite, causing people to normally have an unsatisfied desire for more. Many humans became rapidly addicted to the “sugar high” and fell victim to “sugar toxicity,” often a prelude to diabetes. Massive weight gain and increasingly poor health followed.

Susanna Holt, PhD, has developed the Satiety Index, a system to measure different foods' ability to satisfy hunger. A fixed amount (240 calories) of different foods was fed to participants who then ranked their feelings of hunger every fifteen minutes and were allowed to eat freely for the next two hours. Of all the foods tested, potatoes were the most satisfying. The present invention does not include the use of potato fiber or other potato products as the presence of potato powder may not allow for increased use of the rotein formulation for individuals wanting to maintain or increase their weight.

The Satiety Index scores reflect the total amount of fullness produced by the set portions of the test foods over two hours—i.e. short-term satiety. Although most foods with high Satiety Index scores kept fullness relatively high for the whole two hours, there were a few exceptions.

Fruits were served in very large portions, but fullness dropped off quickly towards the end of the second hour, reflecting the rapid rate of gastric emptying (oranges and apples and grapes are mainly sugar and water). Many ‘health-conscious’ dieters will eat a meal based on several pieces of fruit and some rice cakes and then wonder why they feel ravenous a few hours later. These kinds of extremely low-fat, high-carbohydrate meals do not keep hunger at bay because they are not based on slowly-digested carbs and probably don't contain enough protein. A dieter would be better off eating a wholesome salad sandwich on wholegrain bread with some lean protein like tuna or beef and an apple. This kind of meal can keep hunger at bay for a very long time. Satiety is a gut-to-brain reflex that is regulated primarily by hormones made by the digestive organs during feeding, which float up to the brain to help determine if the satiety feeling is reached. An eating inventory called the CASH scale (reverse acronym: Hunger, Satiety, Appetite, Cravings) to grade individuals' eating behaviors now exist. This inventory may be the first of its kind to correlate eating behaviors with diseases.

On average, using the CASH satiety scale, grades 0-10 can be gauged as follows:
10: Go back for complete second or third helpings.
7 or 8: Go back for more food.
5: Finish plate of food completely and do not go back for seconds.
2-4: Leave food on plate.
0-1: You are so satiated that you can no longer eat.

Most of patients score at least 7, while the diabetics and older patients' scores are significantly higher. Patients with diabetes in the family also score high. In diabetics, the hormone—insulin—is produced in excess. Insulin plays a role in satiety. In a recent study by Leflein Associates for Knoll Pharmaceuticals, manufacturer of Meridian®, only 25% of the subjects studied reported achieving satiety “all the time”; 44% reported “sometimes”; approximately 30% reported “hardly ever.” Half of the surveyed people reported that they continue to eat, even after being “satisfied” to a point of discomfort or “fullness.”

Therefore, as described above, it is not surprising that more than half of the U.S. population is overweight.

In addition to the problems and complications associated with obesity, it is estimated that at least 60% of diseased humans contract the ailment due to improper nutrition or dietary needs that are improperly met to enhance the human condition, primarily by boosting the immune system. The need for proper nutrition that also leads to immune system function enhancement therefore seems vitally important and is related to diet and weight moderation. This is particularly true in developed nations where it is increasingly difficult to find and consume fresh vegetables, fruits, and organically grown livestock. The dangers inherent with the consumption of primarily processed foods (an extremely high percentage in the U.S. and European diets since World War I) have only recently been recognized. The present invention provides nutritional supplementation that enhances the human condition by providing not only satiety with a minimal calorie intake, but also provides immuno-enhancing supplementation and nutritional benefits required by individuals with inadequate dietary needs that may need to maintain or gain weight to reach optimal health.

Today, “protein diets” are exceedingly popular because high protein foods taste good, are satisfying to the appetite, and compliance is easier to maintain. Because of freedom from the “sugar cravings,” most people also lose weight and are better able to keep the extra pounds off. The role of protein and its importance in the present invention is described below. A protein diet supplement that does not stimulate the appetite or create sugar cravings, provides a nutritionally complete protein source, yet is palatable to all and does not have unnecessarily high fat or sugar levels is very desirable. The invention described herein provides these and many additional benefits without the addition of artificially created hunger suppressants. Protein affords many individuals with the ability to quickly reach satiety and thereby more closely regulate caloric intake and weight. Because the protein blend used is critical to the present invention, a full introduction and review of the role that each of the proteins and their various components achieve in the universal formulation is described herewithin.

Meat, poultry, fish, milk, eggs and cheese are considered complete sources of protein because they contain the eight essential amino acids. Nuts and legumes, including navy beans, peas, and soybeans are good sources of protein but are considered incomplete because they do not contain all 8 essential amino acids.

Vegetable combinations, such as corn and beans, do contain all essential amino acids. Although it takes a little extra work determining vegetable combinations that provide all essential amino acids such combinations provide excellent quality protein free of fat and cholesterol.

Milk provides a complete protein in that possesses all 8 essential amino acids. Egg whites also contain a complete protein as well. Combining milk and egg protein may be beneficial in certain formulations such as the preferred embodiment of the present invention, especially if the milk is non fat dry milk and is essentially cholesterol free.

One of the basic questions regarding the choice of protein supplementation is whether there is a single or multiple of protein foods that best promote both cellular health and muscle replenishment. It has been noted that at least 6 of 10 patients that contract diseases during their lifetime do so as a result of dietary insufficiencies that lead to a weakened immune system response. Proper diet and protein supplements can actually boost or enhance the immune system and thereby create a better defense to ward-off illness and disease. The animal proteins, whey & egg whites are currently the favorites used by strength athletes while a multiple of plant proteins from soy, peanut, corn, rice and wheat sources are the favorites of a number of endurance athletes who advocate health as the prime pillar supporting their performance. This is a debatable subject with volumes of numerical definitions, yet it generally lacks a complete, responsible, conclusive rationale. Athletes need to consider which protein or which combination of proteins best enhances the optimal post-workout muscle growth in their bodies. The choice may be resolved after careful evaluation of some of the existing scientific methods for rating protein quality. Pellett & Young summarized this issue well by stating that the concept of a single pattern of amino acids that may be used as a yardstick in comparing the nutritive value of food and diets is subject to the same limitations and qualifications as is the concept of “protein quality”.

The relative proportions in which the essential amino acids are needed almost certainly depend upon the species, its physiological state, and interrelationships and interactions among the amino acids themselves. The pattern of amino acids required for maintenance may be quite different from the optimal pattern to support maximum growth. In addition, the limited accuracy of amino determinations in food and the problem of biological availability of the amino acids present further complications. However, the advantage of a method of dietary assessment in terms of amino acids is considerable, and is, in many circumstances, the only practical approach.

Methods for Determining Protein Quality

In spite of some recognized limitations to this approach, the most accurate method for evaluating protein quality and quantity is measuring an individual's nitrogen-balance. Few individuals are equipped to measure their own nitrogen balance without the assistance of a high-tech sport science laboratory. Since individual nitrogen-balance measures are cost ineffective and time consuming, other scientific methods should be examined to determine what protein quality food choices offer. These methods are known as Biological Value [BV], Protein Digestibility[PD], Net Protein Utilization[NPU], Protein Efficiency Ratio[PER], and Protein Digestibility Corrected Amino Acid Score[PDCAAS], for determining the relative quality from food-source proteins.

Biological Value [BV]

The BV is an accurate indicator of biological activity of protein, measuring the actual amount of protein deposited per gram of protein absorbed. BV measure of protein quality expresses the rate of efficiency with which protein is used for growth. As a rule-of thumb, high BV-proteins are better for nitrogen retention, immunity, IGF-1stimulation, and are superior for reducing lean tissue loss from various wasting states than proteins with a low BV score. Generally, high BV-proteins are more anti-catabolic than low BV-proteins. Strength training applications favor dietary protein sources with a high biological value. On a scale with 100 representing MAX-efficiency, below are listed the biological values [BV] of proteins in several foods:

Protein BV*

Egg 93.7
Milk 84.5
Fish 76.0
Beef 74.3
Soybeans 72.8
Rice, polished 64.0
Wheat, whole 64.0
Corn 60.0
Beans, dry 58.0
   Biological Value [BV]=proportion of protein retained in the human body for maintenance and or growth of cells.

It is also useful to know that there are two basic effects from amino acid profiles on blood lipids. First, high BV proteins raise blood lipids and cholesterol levels while lower BV proteins tend to lower blood lipids and cholesterol levels.

Soy is generally recognized as the best single plant-source food with a complete amino acid profile. Soy is a low BV-protein, lacking a high volume of the sulfur-containing amino acid methionine. The sulfur containing amino acids (cysteine being the other one) are particularly important for protein synthesis/growth, proper immune system function, and the body's production of glutathione (GSH). GSH is one of the most important anti-oxidants found in the body and protects cells and serves to detoxify a variety of harmful compounds such as hydrogen peroxide, carcinogens, reactive oxygen species, and many others. In particular, GSH is partly responsible for keeping low density lipoproteins (LDL) from oxidizing and clogging arteries. Several studies have shown soy protein to be inferior to whey for the production of GSH and improvements in immune system functionality.

Though soy has a reputation for reducing cholesterol in man and animals, in one study rats fed soy protein that was not fortified with methionine as 13% of total calories, had an increase in cholesterol and an increased susceptibility of LDL cholesterol to peroxidation. So not only did the rats cholesterol levels go up, but the LDL fraction oxidized easier, potentially leading to clogged arteries. It is well established that an increased susceptibility of LDL to peroxidation is an essential step for the development of atherogenesis. These rats were found to have low levels of GSH and did not grow as well as another groups of rats fed casein.

The addition of methionine to soy isolates greatly improves soy's BV and nutritional value, though it still does not reach the BV of whole egg or a good whey protein for that matter. However, rats fed soy protein enriched with methionine grew at a similar rate as those fed casein. Some research has suggested that soy is inferior to whey for the production of GSH and improvements in immune system enhancement.

In general, soy protein has been shown to reduce cholesterol in a wide range of animals and man. One recent study found that when they separated the estrogenic compounds from soy, it failed to have the usual cholesterol lowering effects. This does not come as a big surprise, as the cholesterol lowering protective effects of estrogen are well known. However, soy protein appears to have several other mechanisms by which it lowers cholesterol (i.e. isoflavones, endocrine effects, fiber, saponins, etc.)

The specific effects of dietary protein on plasma cholesterol concentrations are well documented; animal proteins tend to be hypercholesterolemic as compared to plant proteins. Although this effect of protein source on plasma cholesterol has been shown in many species, the mechanism is not completely understood. Soy has been shown to reduce cholesterol in both man and animals. Rabbits fed various foods were examined for blood serum cholesterol after 28 days on each protein, the following results in serum cholesterol were reported:

Protein Source Resultant Cholesterol [mmol/l]

Soy Protein Isolate 0.4
Soy Protein Concentrate 0.6
Peanut Protein 2.1
Wheat Gluten 2.1
Egg White[raw] 2.7
Pork Protein Concentrate 2.8
Beef Protein Concentrate 4.1
Casein 5.2
Skim Milk 5.9
Whole Egg Protein 6.1

Soy protein appears to have several inexplicable mechanisms by which it lowers serum cholesterol, from isoflavones, endocrine effects, fiber, saponins or its' relative amino acid ratio structure. Animal studies indicate animal-based proteins produce a high lysine-low arginine ratio which raises serum cholesterol levels, while Soy's lower lysine-higher arginine ratio significantly lowers blood serum cholesterol. Soy's positive effect on cholesterol may also depend on the animal species being studied. In addition to protein-enhanced cholesterol reduction, epidemiological evidence suggests soy may reduce certain forms of cancer. Any protein that has positive implications for optimal blood lipid profiles is likely one that may positively effect both health and athletic performance over time and with prolonged use during training.

Protein Efficiency Ratio [Per] In Animal Has a Limited Application to Humans

Historically, the quality of proteins has been determined by Protein Efficiency Ratio (PER), which measures the weight gain of experimental growing rats when being fed the test protein. Rats have dissimilar protein requirement than humans. This is due to all furry animals requiring more sulfur amino-acids-(methionine, cysteine) to make sulfur-rich hair proteins (keratins). A rat has a whole-body coat of hair, requiring more proportionate-to-bodyweight] methionine/cysteine than humans. The PER-value, as compared to weight gain on the standard protein (casein), gives an indication of the quality of the test protein more for an animal subject, with only limited implications to humans:

Protein Per

Whey Protein 3.6
Milk Protein 3.1
Casein 2.9
Soy Protein 2.1

Protein Efficiency Ratio [PER]=Gain in body weight divided by weight of protein consumed. PER should not be totally neglected because athletes require more sulfur amino-acids-(methionine, cysteine) not for resynthesis of hair but for growing quality muscle fiber after an exercise expenditure. Any protein that has a higher PER value than 2.7 is considered an excellent quality protein.

On the other hand, while maintaining lean muscle mass and minimizing total weight gain are considerations in sports where weight gain may be performance-limiting, the use of soy as a prime protein-of-choice becomes a foregone conclusion. Examples of who should be limiting muscle weight-gains are marathon runners, ultramarathon runners-cyclists, triathletes, or the many cyclists and mountain bike riders who race on courses with steep climbs. Their lean muscle mass gains are performance-enhancing up to a point of “No Return”, after which too much lean muscle mass gain is performance-limiting.

Protein Digestibility Corrected Amino Acid Score [PDCAAS Method]

Nutritionists who disqualify the PER method for classifying protein quality as one for only reflecting the amino acid requirements for the rat, often will reference human protein quality evaluation standards from the “PDCAAS” scale. The Food and Agriculture Organization (FAO) established a new method to compare the quality of various proteins based on the amino acid requirements of humans, which is thought to improve rating protein quality over the PER. This method, known as “Protein Digestibility Corrected Amino Acid Score (PDCAAS) is internationally recognized. According to this method, an ideal protein is one that meets all of the essential amino acid requirements of the human body, noted by a relative rated value of “1.0”. The Protein Digestibility-Corrected Amino Acid Score (PDCAAS) is the latest method for calculating protein quality, accounting for the digestibility of a food protein from its amino acid profile content. The PDCAAS method utilizes an amino acid requirement profile derived from human subjects.

It rationally replaces the Protein Efficiency Ratio (PER), which considered only amino acid growth requirements for rats, whose growth rates were measured by test protein feed lots. PER methods underestimated the value of many of the vegetable proteins. Today, the Food and Drug Administration has endorsed PDCAAS-method for food labeling in the U.S. Applicable to humans, the PDCAAS is patterned after the amino-acid needs of 2-5 year old humans, since this group matches or exceeds amino-acid requirements for older children and adults (who require less than infants). Corrections for digestibility of protein are applied to give a protein-quality rating that's much closer to reality for human metabolism. A PDCAAS can't be higher than the “Complete Score” of 1.0. Soy protein Isolates, Whey Protein Isolates, and Egg Whites are the only proteins scoring a complete “1.00” PDCAAS rating.

Protein Digestibility Corrected Amino Acid Score [PDCAAS]

Protein PDCAAS

SOY 1.00
WHEY 1.00
EGG WHITE 1.00
Beef 0.92
Pea 0.73
Oats 0.57
Peanut 0.52
Rice 0.47
Corn 0.42
Wheat Gluten 0.25

As can be ascertained from the list above, the PDCAAS method favors the use of a combinative protein mixture, or one that at least includes soy, whey or egg white. The proportion of food protein absorbed is called “Protein Digestibility” [PD]. This rating scale also elevates the vegetable amino acid profile of soy to its animal-based counterparts. It should be noted that combinations of plant proteins appear to exceed or equal the amino acid profile of animal-based proteins as noted in the PD-method of protein quality rating below:

Protein Digestibility [PD*] Method for Single & Combinate Food-Protein Source Approximate Adult Digestibility

Corn, Soy, Milk 1.00
Egg 0.97
Milk 0.97
Corn-Soy blend 0.92
Indian Rice Diet+Milk 0.92

Corn, Beans, Milk 0.90
Wheat, Refined 0.89
Soy Protein, Isolated 0.88
Wheat+Soy Protein>0.87
Fish Flour +Millet +
Peanut Flour>0.87
Rice, Polished 0.84
Corn+Beans 0.82
Wheat, Whole 0.79
Soybeans 0.78
Maize 0.76
   *Protein Digestibility[PD]=Proportion of protein absorbed.

This method makes attractive mixing high BV-proteins with low BV-protein favoring maximal muscle growth potential with minimal body fat gain and minimal serum cholesterol volume. A brief description of methodological BV-protein ratings is found above.

Net Protein Ultilization[NPU] METHOD

The NPU method of evaluating protein quality reflects percentages of a food protein retained. The amount of protein eaten versus the amount of protein retained is reflected by the NPU*-rating method as noted below for selected foods:

FOOD NPU*

Eggs 94%
Milk 82%
Brown Rice 70%
Meats [most] 65-57%
Soybeans (alone) 61%
Legumes [alone] 50-60%
Whole Grains 50-60%
   *Net Protein Efficiency Ratio [NPU] =Proportion of protein intake that is retained.
   Soy Has a Positive Metabolic Role Apart From Protein Quality Ratings

Soy protein has been found to raise thyroid output in a wide range of animals from rats to rabbits and pigs. Studies done with human subjects have been harder to quantify, but several studies suggest a positive elevating effect on thyroid hormones in people eating soy protein isolate. Soy protein has been shown to raise thyroid hormone output, which could be a real advantage to bodybuilders trying to shed body fat. The intake of various high quality proteins has been associated with higher levels of thyroid hormone, but soy appears to have thyroid hormone raising abilities unique to that of other proteins. Some research has shown changes in T3 and thyroid stimulating hormone (TSH), the real effect appears to be with T4 which is elevated consistently in the studies done using animals-and to a lesser degree people who eat soy protein.

Other studies have found changes in the insulin/glycogen ratio that would favor reductions in cholesterol and possibly body fat. At this time, exactly how soy proteins have this effect on thyroid output is not well understood, but science is working on it. There may be a relationship between dietary protein source and plasma thyroxin concentration. It is hypothesized that feeding soy protein lowers plasma cholesterol concentration by causing an increase in plasma thyroxin concentrations.

The metabolic changes producing lower cholesterol levels occur when soy protein is fed. These changes are consistent with changes induced by elevating thyroxin. Data presented from animal studies shows that feeding soy protein to laboratory animals consistently elevates plasma thyroxin concentrations. The elevation in plasma thyroxin concentrations precedes the change in plasma cholesterol concentrations. The exception to this finding is persons with pathophysiological thyroid disorders may want to avoid dietary soy proteins, due to a negative systemic hormonal effect. Anyone with thyroid disease or a predisposition to thyroid dysfinction should limit their intake of soy-based protein food. Soy protein isolate has some additional characteristics worth noting with regard to human intake during athletic training and diet. Two points more relevant to strength athletes but that also have implications for the serious endurance athlete are that (1)-Though thyroid hormones are considered catabolic hormones, they are actually more catabolic to fat and carbohydrates, but stimulate protein synthesis if adequate calories are eaten and the amounts of thyroid hormones are not too high. This could be useful for increasing protein synthesis and reducing body fat. More research in this area is required. (2)-When a person diets, the success of that diet is quickly brought to a screeching halt when the body figures out what is occurring and reduces the output of thyroid hormones. This is a reaction by the body brought on by a reduced caloric intake. The use of soy protein isolate to boost thyroid output could be exactly what is needed to keep thyroid levels raised during reduced caloric intake when dieting, if the above evidence with soy proteins and thyroid function holds true in humans on reduced calories diets. This fact would be particularly noticeable during a reduction in calories (i.e. dieting). The lower the calorie intake the higher the quality of protein needs to be to maintain lean body mass. However, soy protein does not have the nitrogen retaining, anti-catabolic, muscle building abilities of proteins such as whey, whole egg, red meat, etc. However, soy does appear to have some other real benefits. So far, it appears that a person does not need to eat a great deal of soy protein isolate to get the benefits. A blend with soy may be the best alternative.

Several nutritionists have proposed a solution to the dilemma from a proven strategy that works well for most athletes. By mixing a high quality whey protein powder with a high quality soy isolate in a 2:1 ratio and supplementing two-three times a day, the athlete may experience the best of all possible worlds (as related to the high BV, immune enhancing, nitrogen retaining abilities of the whey and the cholesterol lowering/thyroid stimulating abilities of the soy). There is no known reason to believe that mixing these two proteins will negate or interfere with the benefits or properties of either protein, since there is only scant research with healthy athlete subjects.

Conclusions for Applications: Specific Proteins for Specific Applications

A. During pre-event or preseason strength training phases, use of only Whey Proteins as a supplement regular dietary protein with intake volumes of up to 66% of required protein intake. This protocol suggests consuming 3 parts Whey Protein to 1part Vegetable or other protein.

B. During ENDURANCE PEAK phases use a 2 portion Whey Protein to 1 portion Soy Protein to maintain strength while lowering blood lipid fractions to minimal levels. Specifically measure the 2:1 gram ratios by reading the ingredients label panels.

C. During CALORIC RESTRICTION or weight control management phases, use Soy protein only as a supplement source to lean muscle mass maintenance for body fat reduction.

D. During STRENGTH TRAINING phase protein VOLUME intake should be ideally 1.7 grams per kilogram body weight and no lower than 1.4 grams per kilogram body weight during all other phases. Negative nitrogen balance may occur at 1.0 grams per kilogram body weight resulting in lean muscle mass loss. Excess positive nitrogen balance may occur when athletes consume more than 2.0 grams protein per kilogram body weight, resulting in adipose tissue fat gain and excessive strain on the liver and kidney glands.

E. If “HEALTH” from training is your goal/focus, dietary implementation of the following dietary percents of each protein food class will provide a superb amino acid profile to support optimal “Blood Lipid Profile” balance:

Egg Whites-20%, Whey-20%, Soy-40%, Fish-10%, and Vegetable mixedprotein sources-10%. This dietary profile also meets and/or exceeds the requirements set in each category listed in A, B, C, & D above.

An Equal Rating for Each Protein from Methodology Guidelines

While this is may not be qualified as “real” science; a rating system for each individual protein from the former mentioned methods presented above may be determined by assigning a descending-ordered score of 10-9-8-7-6-5-4-3-2-1 points for rating each protein quality by each method. By totaling the average points we determine a ranking scale for each protein as follows:

Protein Average Score (Equal Rating Methodology)

Egg 9.25
Whey 8.20
Casein 7.80
Milk 7.80
Fish 7.50
Soy 7.20
Peanut 7.00
Pork 6.50
Rice 6.30
Beef 6.30
Wheat 6.00
Corn 3.50
Beans 3.50

A relationship between more complete protein and less complete protein sources has been shown. It should be noted that the transit time from mouth to activating muscle cell growth ranges from 24 to 72 hours, depending on age, gender, genetic predisposition and individual fitness response to exercise stress. A combination of 2 or more protein food sources in a sufficient volume dose of 1.4 to 1.7 grams protein per kilogram of bodyweight meets most athlete' amino acid requirements.

Choice of “Higher Ranked” proteins or protein combinations may insure a more rapid growth rate and enhanced post-exercise recovery rebound in athletes and other individuals. Such meager dietary differences may provide the differences between lifetime capabilities in any and all physical activities and lifetimes filled with inability to physically cope with any endurance or strength demands. More specifically, the sustained health, vigor and immune system responsiveness may be enhanced with the use of a properly selected mixed protein source enhancer such as provided by the present invention.

As can be ascertained from the list and scoring system provided above, the four sources of protein are egg, whey, casein and milk scored the highest. Each of the four are blended in the protein formulation of the present invention.

Specifically, next, it will be shown specifically why egg white is perhaps the most single most desirable protein of those listed above and of the four chosen as the blend for the present formulation.

Egg whites are an excellent source of biologically valued protein because they provide the only protein which is instantly absorbed by the body. Other high protein foods like: beef, fish, chicken, and turkey must first be broken down by the body (see discussion on peptides and amino acids below) before the proteins can be absorbed. Even then, not all humans can metabolize meat protein properly. The same is true for protein powders and other meal replacements. It should also be noted that egg whites have no fat, and no cholesterol. The powdered egg whites have to be heat treated to be dried and therefore are not raw nor will they destroy biotin.

The nutritional value and type of naturally occurring proteins found in the egg white (prior to drying) are listed below and herein included for completeness such that any and all of the naturally occurring egg proteins are included in part or whole of the present formulations;

TABLE 1
Egg white (*per 100 g):
11 g protein:

ovomucin
ovalbumin
ovomucoid
ovoglobulin
conalbumin
(87.8 g water)

To further demonstrate the nutritional and health value of egg white protein in the formulation of the present invention, several specifics regarding the egg are provided in Tables 2-4 below. Each of the constituents associated with the egg white are essential to the formulation of the present invention and provide benefits which exist and are too numerous for complete documentation.

The chemical composition and nutrient values of the egg white (based on the entire egg are best detailed in Table 2 below;

TABLE 2
Chemical Composition of the Chicken Egg

| | Liquid*/Frozen | | | | | Dried | | |
|---|---|---|---|---|---|---|---|---|
| Nutrients | Whole | | Sugared | Salted | | Whole | | Stabilized |
| (per 100 g) | Eggs | Yolk | Yolk | Yolk | White | Eggs | Yolk | White |
| PROTEIN - g | 11.95 | 15.5 | 13.8 | 14 | 9.8 | 47.35 | 34.25 | 82.4 |
| MOISTURE - g | 75.85 | 56.2 | 51.25 | 50.8 | 88.55 | 3.1 | 2.95 | 8.54 |
| FAT (TOTAL LIPID) - g | 10.2 | 25.6 | 22.75 | 23 | 0 | 40.95 | 55.8 | 0.04 |
| ASH - g | 0.95 | 1.55 | 1.4 | 10.6 | 0.6 | 3.65 | 3.4 | 4.55 |
| CARBOHYDRATE - g | 1.05 | 1.15 | 10.8 | 1.6 | 1.05 | 4.95 | 3.6 | 4.47 |
| CALORIES - cal | 148 | 303 | 307 | 274 | 47 | 594 | 666 | 376.07 |
| CHOLESTEROL - mg | 432 | 1075 | 959 | 955 | 0 | 1715 | 2335 | 0 |

TABLE 3
Vitamins found in the Chicken Egg

| | Liquid*/Frozen | | | | | Dried | | |
|---|---|---|---|---|---|---|---|---|
| VITAMINS | Whole | | Sugared | Salted | | Whole | | Stabilized |
| (per 100 g) | Eggs | Yolk | Yolk | Yolk | White | Eggs | Yolk | White |
| NIACIN - mg | 0.08 | 0.05 | 0.02 | 0.04 | 0.1 | 0.31 | 0.1 | 0.72 |
| RIBOLFAVIN - mg | 0.46 | 0.52 | 0.53 | 0.43 | 0.4 | 1.54 | 1.88 | 2.32 |
| B12 - mcg | 1.07 | 1.82 | 1.77 | 2.52 | 0.06 | 3.95 | 5.33 | 0.53 |
| PANTOTHENIC ACID - | 1.48 | 3.53 | 3.2 | 3.23 | 0.16 | 5.91 | 7.77 | 1.96 |
| mg | | | | | | | | |
| VITAMIN A - IU | 525 | 1410 | 1315 | 1190 | 0 | 900 | 1315 | 0 |
| THIAMIN - mg | 0.06 | 0.16 | 0.14 | 0.13 | 0.01 | 0.2 | 0.29 | 0.04 |
| PYRIDOXINE (B6) - | 0.16 | 0.35 | 0.28 | 0.26 | 0 | 0.39 | 0.66 | 0.02 |
| mg | | | | | | | | |
| FOLIC ACID - mcg | 73 | 116 | 139 | 107 | 3 | 171 | 244 | 95.7 |
| VITAMIN E - mg/ATE | 1.07 | 2.5 | — | — | 0 | 4.38 | 6.42 | 0 |
| VITAMIN D - IU | — | — | — | — | — | 188 | — | — |

As can be determined from Table 3 above, the egg white is deficient in both vitamin A (palmitate) and vitamin D (cholecalciferol), which are both replacement additives in the preferred formulation of the present invention.

TABLE 4
Minerals found in the Chicken Egg

| | Liquid*/Frozen | | | | | Dried | | |
|---|---|---|---|---|---|---|---|---|
| MINERALS | Whole | | Sugared | Salted | | Whole | | Stabilized |
| (per 100 g) | Eggs | Yolk | Yolk | Yolk | White | Eggs | Yolk | White |
| CALCIUM - mg | 59 | 138 | 123 | 114 | 7 | 231 | 284 | 89.4 |
| IRON - mg | 1.85 | 3.34 | 3.14 | 3.75 | 0.05 | 6.79 | 5.42 | 0.24 |
| MAGNESIUM - mg | 11 | 9 | 10 | 10 | 10 | 42 | 13 | 71.84 |
| PHOSPHORUS - mg | 202 | 417 | 384 | 431 | 13 | 831 | 920 | 89.4 |
| POTASSIUM - mg | 130 | 118 | 103 | 117 | 136 | 493 | 244 | 1115.7 |
| SODIUM - mg | 133 | 67 | 67 | 3780 | 158 | 523 | 135 | 1238.4 |
| ZINC - mg | 1.38 | 2.88 | 2.81 | 2.84 | 0.02 | 5.28 | 4.93 | 0.16 |
| COPPER - mg | 0.05 | 0.02 | 0.01 | 0.11 | 0.01 | 0.2 | 0.01 | 0.17 |
| MANGANESE - mg | 0.03 | 0.06 | 0.06 | 0.06 | 0.01 | 0.13 | 0.12 | 0.05 |
| SELENIUM - mcg | 30.8 | 41.8 | 37.7 | 37.7 | 17.6 | 119.6 | 86.8 | 125.1 |

Egg whites are high in certain mineral contents, such as potassium and sodium; however zinc, copper, and manganese may be supplemented as with the preferred embodiment of the present invention. Egg whites contain no lipids at all, which allows for a cholesterol free protein supplement if so desired.

TABLE 5
Amino Acids found in the Chicken Egg

| | Liquid*/Frozen | | | | | Dried | | |
|---|---|---|---|---|---|---|---|---|
| AMINO ACIDS | Whole | | Sugared | Salted | | Whole | | Stabilized |
| (mg/100 g) | Eggs | Yolk | Yolk | Yolk | White | Eggs | Yolk | White |
| ALANINE - g | 0.67 | 0.8 | 0.71 | 0.72 | 0.57 | 2.64 | 1.76 | 5.31 |
| ARGININE - g | 0.72 | 1.11 | 0.99 | 1 | 0.53 | 2.84 | 2.44 | 4.81 |
| ASPARTIC ACID - g | 1.2 | 1.52 | 1.35 | 1.37 | 1 | 4.76 | 3.35 | 7.29 |
| CYSTINE - g | 0.28 | 0.28 | 0.25 | 0.25 | 0.25 | 1.1 | 0.61 | 2.04 |
| GLUTAMIC ACID - g | 1.56 | 1.96 | 1.75 | 1.77 | 1.3 | 6.19 | 4.34 | 11.50 |
| GLYCINE - g | 0.4 | 0.48 | 0.43 | 0.43 | 0.34 | 1.59 | 1.06 | 3.09 |
| HISTIDINE - g | 0.28 | 0.4 | 0.36 | 0.36 | 0.22 | 1.12 | 0.89 | 1.87 |
| ISOLEUCINE - g | 0.65 | 0.78 | 0.7 | 0.71 | 0.55 | 2.58 | 1.73 | 5.02 |
| LEUCINE - g | 1.02 | 1.36 | 1.21 | 1.23 | 0.83 | 4.05 | 3.01 | 7.17 |
| LYSINE - g | 0.86 | 1.23 | 1.1 | 1.11 | 0.67 | 3.4 | 2.72 | 5.08 |
| METHIONINE - g | 0.37 | 0.38 | 0.34 | 0.35 | 0.34 | 1.48 | 0.85 | 3.20 |
| PHENYLALANINE - g | 0.64 | 0.66 | 0.59 | 0.6 | 0.57 | 2.52 | 1.46 | 5.18 |
| PROLINE - g | 0.48 | 0.65 | 0.58 | 0.59 | 0.38 | 1.89 | 1.43 | 3.10 |
| SERINE - g | 0.89 | 1.32 | 1.18 | 1.2 | 0.68 | 3.52 | 2.93 | 6.08 |
| THREONINE - g | 0.57 | 0.82 | 0.73 | 0.74 | 0.45 | 2.27 | 1.82 | 3.67 |
| TRYPTOPHAN - g | 0.15 | 0.18 | 0.16 | 0.16 | 0.12 | 0.58 | 0.4 | 1.27 |
| TYROSINE - g | 0.49 | 0.69 | 0.61 | 0.62 | 0.38 | 1.93 | 1.52 | 3.31 |
| VALINE - g | 0.73 | 0.86 | 0.77 | 0.78 | 0.62 | 2.89 | 1.91 | 6.17 |

As stated above and shown in Table 5, egg whites contain all essential amino acids and the egg whites are a fat-free protein source.

Eggs are compatible in most food ingredient systems, blending without adverse reactions or difficulties. FIG. 1 below indicates the manufacturing methodology leading to the production of egg whites and other egg products. Careful processing assures high quality safe products. All egg white products must be pasteurized and high speed automation carefully separates shells, yolks, and whites.

[image]

In addition to the desire to provide the best possible protein source and blend, including that of the egg white, an issue regarding amino acids, the constituents of all proteins, must be addressed. Food and tissue proteins contain 20 amino acids of nutritional importance. An essential amino acid for an organism is an amino acid that cannot be synthesized by the organism from other available resources, and therefore must be supplied as part of its diet. Eight amino acids are generally regarded as essential for humans: tryptophan, lysine, methionine, phenylalanine, threonine, valine, leucine, isoleucine. Two others, histidine and arginine are essential only in children they are therefore essential or indispensable nutrients that must be obtained from the diet.

The other 11—alanine, arginine, aspartic acid, asparagine, cystine, glutamic acid, glutamine, glycine, proline, serine, and tyrosine—are also ordinarily obtained from the diet, but the body can synthesize them. They are therefore not essential nutrients; they are nutritionally dispensable or nonessential. They are, nevertheless equally as important as the indispensable amino acids for the nutrition of cells and for nonnal cell and organ function.

Which amino acids are essential, varies from species to species, as different metabolisms are able to synthesize different substances. For instance, taurine (which is not, by strict definition, an amino acid) is essential for cats, but not for dogs. Thus, dog food is not nutritionally sufficient for cats, and taurine is added to commercial cat food, but not to dog food.

The distinction between essential and non-essential amino acids is somewhat unclear, as some amino acids can be produced from others. The sulfur-containing amino acids, methionine and homocysteine, can be converted into each other but neither can be synthesized from scratch in humans. Likewise, cysteine can be made from homocysteine, but not from scratch. So, for convenience, sulfur-containing amino acids are sometimes considered a single pool of nutritionally-equivalent amino acids. Likewise arginine, ornithine, and citrulline, which are interconvertible by the urea cycle, are considered a single pool.

Methionine and phenylalanine are required as specific precursors for the synthesis of the dispensable amino acids cysteine and tyrosine, respectively but the other dispensable (nonessential) amino acids can be synthesized from organic acids that are intermediates in the metabolism of carbohydrates and nitrogen from surpluses of other amino acids or even from ammonium sales.

Some amino acids that are ordinarily nutritionally dispensable may not be synthesized in large enough amounts to meet the body's needs if the metabolic pathways for their synthesis are immature or impaired. This appears to be the case with cysteine and tyrosine in premature infants and possibly with taurine there is also evidence that, after severe trauma, glutamine may not be synthesized in adequate amounts. Thus, under some conditions, certain dispensable amino acids may become conditionally indispensable. The requirement for protein is thus a dual requirement—for nine amino acids that the body cannot synthesize and some that may not be synthesized in adequate amounts and for nitrogen needed for the various nitrogenous compounds that are synthesized continuously.

The carbon skeleton of amino acids can be oxidized by the body, so surpluses of protein and individual amino acids can also serve as sources of energy. Organs and tissues differ greatly in their ability to use amino acids as energy sources. The liver has the capacity to oxidize most amino acids and, if they are in surplus, will oxidize them in preference to other energy-yielding molecules. Most of the indispensable amino acids are not oxidized in other tissues, but the branched-chain amino acids—leucine, isoleucine, and valine—like many of the dispensable amino acids, can be oxidized by most tissues and organs. Glutamine and glutamic acid are preferential energy sources for the intestine and lymphocytes.

Foodstuffs that lack essential amino acids are poor sources of protein equivalents, as the body tends to deaminate the amino acids obtained, converting proteins into fats and carbohydrates. Therefore, a balance of essential amino acids is necessary for a high degree of net protein utilization, which is the mass ratio of amino acids converted to proteins to amino acids supplied.

The net protein utilization is profoundly affected by the limiting amino acid content (the essential amino acid found in the smallest quantity in the foodstuff), and somewhat affected by salvage of essential amino acids in the body. It is therefore a good idea to mix foodstuffs that have different weaknesses in their essential amino acid distributions. This limits the loss of nitrogen through deamination and increases overall net protein utilization.

TABLE 6

| Protein | |
|---|---|
| source | Limiting amino acid |
| wheat | lysine |
| rice | lysine and threonine |
| maize | tryptophan and lysine |
| pulses | methionine |
| beef | methionine and cysteine |
| whey | None |

It is therefore also desirable to provide a protein blend source complete with at least all the essential amino acids and both egg white and whey proteins exhibit this characteristic.

For convenience and clarity a list of all the essential and non-essential amino acids is provided as an indicator of the importance of each and the desired ability to provide a comprehensive inclusion of all amino acids in an optimal protein blended formulation.

Essential Amino Acids

Tryptophan—considered a natural relaxant, helping to relieve insomnia, for treatment of migraine headache symptoms, reducing risk of heart and artery spasms, and works with lysine to reduce cholesterol.

Lysine—aids in absorption of calcium, helps form collagen for bones, cartilage and connective tissues, aids in the production of antibodies, hormones and enzymes, helps people with the herpes virus (which can cause chronic fatigue syndrome and symptoms). Methionine—provides a primary source of sulfur that can prevent disorders of the skin, hair, and nails. Lowers cholesterol, reduces liver fat, protects kidneys and promotes hair growth.

Phenylaline—produces norepinephrine (the chemical that is responsible for transmitting signals between the nerve cells and the brain) helping maintain alertness, optimism, and ambition. Reduces hunger pains (appetite), relieves pain in conditions such as arthritis, menstrual cramps, and migraine headaches. Acts as an antidepressant and improves memory.

Theronine—makes up a substantial portion of collagen, elastin, and enamel proteins. Prevents buildup in the liver, aids in digestive and intestinal tract function and acts as a trigger for metabolism.

Valine—promotes mental energy, helps muscle coordination and serves as a natural tranquilizer.

Leucine—works with isoleucine to provide the manufacture of essential biochemical processes in the body for energy. Increases stimulants to the upper brain for greater mental alertness.

Nonessential Amino Acids

Glycine—facilitates releases of oxygen for cell making processes. Plays a key role in the manufacturing of hormones and also in the health of the immune system. Serine—source of glucose storage by the liver and muscles. Provides antibodies for the immune system, synthesizes fatty acid sheath around nerve fibers.

Glutamic Acid—nature's “brain food” increase mental prowess helps speed healing of ulcers and aids in combating fatigue.

Arginine—truly an all purpose substance affecting everything from growing to healing of the skin, to liver detoxification, to strengthening immune systems. Promotes the secretion of several hormones, including glucagons, insulin, and growth hormones.

Creatine—an energy & muscle builder and natural bodybuilding supplement. Assists in the production of energy and the building of muscle. The natural supply of creatine produced by the body is quickly depleted. After about 10 seconds of vigorous exercise, when muscle fatigue becomes apparent, the daily supply of creatine produced by the body is burned. It is of high importance to supplement the diet with creatine, especially when active.

Carnitine—actually a cousin to the true amino acids. It is not involved in the protein building process, but in the body's fat burning functions, especially in liver cells and heart muscles.

Glutamine—our muscles have more glutamine in them than any other amino acid. It is one of the few things that can cross the “blood barrier” and stimulates mental processes like learning and alertness. Used as a remedy for arthritis, tissue damage, connective tissue diseases, and for intestinal ailments like peptic ulcers.

Histadine—a compound released by the immune system cells during an allergic reaction. Research reports low levels of histadine in some persons with arthritic conditions. N-Acetyl-Cysteine (NAC)—an altered form of the amino acid cysteine. Helps the body synthesize glutathione (an antioxidant). It has been shown that low levels of glutathione can leave the body vulnerable to further immune compromise in HIV-infected individuals.

A protein is defined as a macromolecule composed of one or more polypeptide chains, each with a characteristic sequence of amino acids linked by peptide bonds. The human body may be comprehended in terms of a society in that diversity results in higher functionality. The human body functions better using different molecular-weight whey peptides. Low molecular-weight whey peptides (MW 500-14,000 D) are clinically proven to produce faster nitrogen absorption rates and better nitrogen retention than regular proteins such as milk or egg white. Medium and high molecular-weight whey peptides (MW 10,000-160,000 D) provide a steadier state, more prolonged nitrogen absorption profile as well as boosting intra-cellular antioxidant activity.

Until 1992, doctors mistakenly assumed all proteins were digested in the same way and at the same rate. Then, Dr. Daniel Tome of the French Biologie et Nutrition Humaine discovered that many whey peptides naturally bypass ordinary digestion processes by passing quickly through the stomach intact where they are absorbed directly by the lower intestines.

Using radioactive tracer techniques to determine the accuracy of and causes for this process, Dr. Tome and his colleagues found that a fill spectrum of whey peptides (short and long chains of amino acids) appear to be absorbed faster and better, with a substantial portion remaining unaffected by stomach acids or enzymes.

Free-form amino acids produce inferior nitrogen retention compared to intact proteins or peptides for two main reasons. First, free-form amino acids are absorbed at different rates; as much as two hours apart. Second, free-form amino acids actually compete with one another for uptake through the intestinal lining. This competition limits the rate of absorption.

Amino acid transport and breakdown is therefore vitally important in determining how, how fast, and what portion of a protein exactly is delivered to the blood stream and eventually the tissue and cells of a human. The illustration below indicates the tortuous route that occurs with various proteins as they reach the venous blood system.

[image]

Peptides and Nitrogen Retention

Because short chains of amino acids are absorbed faster and more completely than free-form amino acids, it is not surprising that up to 70% of the nitrogen absorbed and appearing in the bloodstream is from peptides, rather than free-form amino acids. The superiority of peptides over free-form amino acids to promote better nitrogen retention is so well accepted that pharmaceutical companies have developed separate molecular-weight peptide formulas to address different patient conditions. This practice is based upon the realization that a patient undergoing abdominal surgery, for example, has different needs than an AIDS patient or recent burn victim. Different proteins are comprised of different peptides and amino acids and therefore, again, the use of a protein blend to enhance and optimize the health of individuals appears warranted.

Selected key research-proven benefits of peptides in nutritional support include the following;

Gastrointestinal

Improved absorption; less diarrhea.
Stimulation of gut mass; prevention of atrophy.
Maintenance of gut integrity; prevention of bacterial translocation.
   Liver Function
Maintenance of hepatic function.
Improved visceral protein synthesis.
   Endocrine
Improved secretion of trophic gut hormones.
Improved IGF-1 production.
   Nitrogen Utilization
Improved nitrogen balance.
Improved growth.

Outcome; improved survival in experimental models; i.e., hemorrhage, bum, chemotherapy, radiation victims.

The Importance of Glycomacropeptides

Glycomacropeptides are unique peptides composed of a chain of 64 amino acids with a molecular weight (MW) of 6,700 Daltons (D). They are quite rich in BCAAs (branched-chain amino acids) and glutamic acid, which enhance and offer powerful biological activity. Dr. Douglas Willen has stated that complete glyconutrition provides immune balance, fortification, and maintenance. Glyconutritionals are very unique because they are immune system modulators. This means glyconutrient supplementation can help to correct an overactive immune system (auto-immune diseases), boost an under active immune system (chronic or recurring infections), and keep immune armies in tip-top shape for exceptional disease prevention.

The range of health-boosting benefits for both glycosaccharides and glycomacropepetides is impressive. Glycomacropeptides help suppress appetite, by stimulating the release of cholecystokinin (CCK), a hormone that signals the brain of “fullness”. In one study, glycomacropeptides from whey increased CCK release by 415%. The glycomacropeptites also improve intestinal health, by preventing stomach disorders caused by bacteria and viruses. They prevent heartburn, by reducing gastric acid secretion by as much as 53%, reduce inflammation in the newborn's stomach, by regulating immune response, lower the risk of heart attack and stroke, by inhibiting platelet aggregation and binding of I-fibrinogen to platelets, prevent influenza, through their antimicrobial and antibacterial qualities and help prevent cavities, by inhibiting the adhesion of tartar to teeth.

Glycomacropeptides are cleaved from kappa-casein, a component of milk. Thus, they are found in the “natural” whey that is a by-product of the cheese-making process. These multi-beneficial peptides are present in manufactured whey protein supplements in greater or lesser quantity, depending upon the type of production utilized. In higher-quality supplements, the percentage of glycomacropeptides may reach 17%. These peptides are entirely lost in the ion-exchange method of production, resulting in an inferior product in terms of full health potential benefits.

The healthy bioactive peptides are formed specifically during enzymatic hydrolysis of egg white proteins. They are nutraceutical/functional foods that join other food with therapeutic activity. As described above, the peptides have anti-hypertensive activity and/or antioxidant activity.

In lieu of formulating products with expensively refined components, manufacturers will list the composition of a less refined ingredient such as stating that the components include a full spectrum of whey protein fractions including beta lactoglobulin ˜55%, alpha lactalbumin ˜15%, glycomacropeptides ˜21%, immunoglobulins ˜3%, bovine serum albumin ˜2%, lactoferrin, etc. The underlying principal is that if ion-exchange is not used during production of the protein, the peptide composition and functionality remains high.

To further emphasize the value of the egg white proteins, it has been determined that a Spanish public research institution is offering licenses for an invention that deals with healthy products obtained by enzymatic hydrolysis the proteins. These healthy peptides (also known as small proteins) are nutraceutical/functional foods that bind food with therapeutic activity. The peptides have anti- hypertensive activity and/or antioxidant activity. The patented nutraceutical products including hydrolyzed or bioactive peptides, are attractive both for the food and the pharmaceutical industry. The invention deals with the production of egg-derived products containing bioactive peptides with in-vitro angiotensin-converting enzyme inhibitory activity and/or anti-hypertensive activity and/or antioxidant activity. These bioactive peptides are formed by enzymatic hydrolysis of egg white proteins. The bioactive peptides are produced through hydrolysis of one or more proteins, peptides of fragments thereof, comprising the amino acid sequence of bioactive peptides (preferably ovoalbumin or mixtures of ovoalbumin). In a preferred embodiment the protein or proteins are enzymatically digested with pepsin but any enzyme and hydrolysis conditions that allow breakdown of the protein sequence at the desired peptide bonds may be used. Alternatively, these bioactive peptides can also be produced by other methods, such as chemical synthesis, recombinant production, etc. The peptides may be consumed as such, in the form of crude hydrolysates, concentrates of low molecular weight or other active sub-fractions obtained by size separation methods or chromatographic methods. These active hydrolysates, their fractions or the purified peptides can be employed in food products or pharmaceutical formulae. In this way, these products may be used in the prevention and treatment of several pathologies, particularly in blood pressure regulation. The invention reports for the first time the in-vitro angiotensin-converting enzyme's inhibitory activity and antioxidant activity of the identified peptide sequences. Demonstration of the in-vivo anti-hypertensive activity of ovoalbumin and egg white hydrolyzed is also original.

Therefore, again it has been demonstrated that the use of egg white as one of the sources of a protein blend is extremely desirous and is included as part of the present formulation of the invention. The use of non-fat dry or powdered milk enhances the bioactive peptide availability. Non-fat powdered milk was first derived from whole milk. Now, the industry offers refined milk proteins in the form of caseinates and whey protein concentrates to isolates. Items that have an even higher value are further refined milk proteins and peptides in the form of lactoferrin, alpha-lactoglobulin or glycomacropeptides. In addition milk contains colostrum which is the first milk produced by mammals before the onset of lactation. This substance is rich in protein and immune-protecting transfer factors. Studies show that colostrum supports the immune system of the newborn, and it can also improve health later in life. It helps increase the number immunoglobulin proteins in the intestinal tract to fight foreign microorganisms.

In the entire scheme of providing health and well-being to humans, the proper diet, complete with the proper essential and non-essential amino acids, peptides, and ultimately the proper protein blend are all important as an essential ingredient toward that end. Many of the symptoms of illness or measures of health can show improvement in days or weeks with proper diet and nutrition. For instance, many diabetic patients also have hypertension, sleep apnea, fatigue, acid reflux, and joint or muscle pain. Each of these conditions may improve at different rates and respond differently to addition of proper or improper food groups, including food supplementation. By measuring each symptom, the patient may discover that a particular food group is associated with adverse results resulting in one symptom/illness but the same food group may improve the health and well-being in another individual. Therefore, providing a universal protein formulation meeting multiple dietary needs for optimal health is a challenge which is difficult to obtain. The formulation of the present invention, however, addresses this need with the understanding that each individual's exact nutritional requirements are different and that each individual's needs change during the course of a lifetime. A common goal is to assist individuals with boosting immune system response and functionality, which the present formulation is also designed to accomplish.

### DESCRIPTION OF PRIOR ART

U.S. Pat. No. 6,455,095 to Wong, et. al., assigned to ThermoBean, L. P., describe a dietary supplement for legume protein, comprising galactosidase, methionine, medium chain fatty acids or their derivatives, and optionally containing thermogenic additives.

U.S. Pat. No. 6,669,952 to Waggle, et. al., and assigned to Solae, LLC, describe a composition, comprising an isoflavone material free of soy protein containing at least one isoflavone selected from the group consisting of genistein, daidzein, glycitein, biochanin A, formononetin, and their naturally occurring glycosides and glycoside conjugates, wherein said isoflavone material contains glycitein, glycitin or 6″-O-malonyl glycitin; and a plant sterol, where said plant sterol comprises at least 0.49 weight percent of said composition.

U.S. Pat. No. 6,811,798 to Monagle, et. al., and assigned to Solae, LLC, describe a method for manufacturing a protein product comprising providing a substantially defatted soybean material treating said material with an enzyme at an effective temperature and pH for an effective time to achieve a combined monosaccharide and sucrose content of at least 10% of total dry matter in said product and a combined raffinose and stachyose content of less an 5% of total dry matter in said product removing fiber from said material before or after said treatment to achieve at least 60% protein of total dry matter in said product inactivating said enzyme after said treatment.

U.S. Pat. No. 6,811,804 to Patel, et. al., and assigned to Abbott Labs, describe a juice and soy protein beverage comprising a protein source supplying from about 10% to about 30% of the total calories of the product, wherein said protein source comprises at least one source of soy protein; and a source of carbohydrate supplying from about 70% to about 90% of the total calories of the product, wherein said carbohydrate source comprises at least 10% by total weight juice selected from the group consisting of fruit juice and vegetable juice, and wherein the beverage has a Brix:acid ratio of from about 10 to about 40.

U.S. Pat. No. 4,259,358 to Duthie, Iain, and assigned to Agricultural Production and Vegetable Products, Ltd, describes a process for preparing a food product containing readily-assimable nutrients in the form of protein and low molecular weight carbohydrates comprising treating an aqueous liquid slurry, having a pH of 8 or less, of comminuted vegetable tissue selected from the group consisting of ground legume material and flaked legume material, the weight ratio of said legume material to said aqueous liquid being from 1:1 to 1:15 on a dry matter basis, said legume material being derived from edible seeds of leguminous plants belonging to the family Leguminosae and having a protein content of from 15 to 48% and a starch content of from 35 to 75% and having a lipid content of 0.5 to 5.0% on a dry matter basis or being derived from legumes of the genus Lupinus having a protein content of from 40 to 50%.

U.S. Pat. No. 5,100,679 to Delrue, Rita, and assigned to Cargill, BV, describes a method of making a proteinaceous product by treating sources of vegetable protein and carbohydrates that contain non-starch polysaccharides to improve palatability, digestibility, and minimize proteinaceous antinutritional factors and antigenicity factors, which comprises preparing an aqueous slurry of vegetable proteins and carbohydrates adjusting the pH of the slurry between about 3.5 and about 6 pretreating the slurry to reduce the viscosity below about 4000 cps by reacting a viscosity reducing agent with the slurry heating the slurry to a temperature between about 85° C. and about 155° C. for a period of time to substantially minimize proteinaceous antinutritional factors and antigenicity factors cooling the slurry so that a hydrolyzing agent that is added in step (f) is not inactivated hydrolyzing the slurry with a hydrolyzing agent from a source of alpha-galactosidase.

U.S. Pat. No. 6,113,972 to Corliss, et. al., and assigned to Monsanto, Co., describe a phytosterol protein complex for increasing the bioavailability of a phytosterol constituent so as to deliver said phytosterol constituent to a human, wherein said phytosterol protein complex is comprised of an amount of said phytosterol equal to between about 5% and about 80% by weight of said phytosterol protein complex an amount of protein equal to between about 20% and 90% by weight of said phytosterol protein complex and an amount of edible oil equal to between about 5% and 20% by weight of said phytosterol protein complex.

U.S. Pat. No. 6,630,178 to HOIE, Lars Henrik, and assigned to Nutri Pharma Asa, describe a composition comprising a soy protein source, selected from the group consisting of isolated soy protein, soy protein concentrate and soy flour, said soy protein source providing an amount of soy protein, which is at least 45 weight percent of the total protein content of the composition, said total protein content providing at least 15 percent of the total energy content of the composition at least one phytoestrogen compound in an amount of more than 0.16 weight percent of the soy protein content of the composition and dietary fibers in an amount of more than 6 weight percent of the total weight of the composition on a dry basis.

U.S. Pat. No. 6,572,876 to Waggle, et. al., and assigned to Solae, LLC, describe a method for lowering blood concentration of total and low density lipoprotein (LDL) cholesterol in a human, comprising co-administering a plant sterol and a soy protein material containing at least 49 weight percent soy protein and containing glycitin, an isoflavone glycoside, to a human to decrease the blood concentration of total and LDL cholesterol in said human, where said plant sterol comprises at least 0.49 weight percent of the combined weight of the co-administered plant sterol and soy protein material.

U.S. Pat. No. 6,544,566 to Waggle, et. al., and assigned to Protein Technologies International, Inc, describe a composition comprising a soy protein material containing at least 49% soy protein by dry weight of the soy protein material an isoflavone material containing at least one isoflavone selected from the group consisting of genistein, daidzein, glycitein, biochanin A, formononetin, and their naturally occurring glycosides and glycoside conjugates, wherein said isoflavone material contains glycitin or 6” -O- malonyl glycitin and a plant sterol, where said plant sterol comprises at least 0.49% of said composition by weight.

U.S. Pat. No. 6,509,043 to HOIE, Lars Henrik, and assigned to Nutri Pharma Asa, describe a method of treating a disease in a human or animal body, said method comprising administering to said human or animal body an effective amount of a composition comprising a soy protein source, selected from the group consisting of isolated soy protein, soy protein concentrate and soy flour, said soy protein source providing an amount of soy protein, which is at least 45 weight percent of the total protein content of the composition, said total protein content providing at least 15 percent of the total energy content of the composition at least one phytoestrogen compound in an amount of more than 0.10 weight percent of the soy protein content of the composition and dietary fibers in an amount of more than 6 weight percent of the total weight of the nutritional composition on a dry basis, said disease being selected from inflammation of the airways, bronchoconstriction, bronchitis, asthma, small airways diseases, mucus hypersecretion and dyspnea.

U.S. Pat. No. 6,497,906 to Kelly, Graham, and assigned to Novogen Research Pty. Ltd., describe human dietary supplement comprising soy material consisting essentially of a ground soy hypocotyl material containing at least one isoflavone.

U.S. Pat. No. 6,787,178 to Yamamoto, Kiyoshi, describe a health drink composed of 3-15% by mass of soymilk calculated as a solid content, 0.2-8% by mass of egg white calculated as a solid content 0.1-5% by mass of a sweetener calculated as a solid content and the balance is water.

U.S. Pat. No. 6,720,020 to Karleskind, et. al., and assigned to Cargill, Inc., describe protein supplemented beverage composition comprising a modified oilseed material, wherein the modified oilseed material comprises at least about 85 wt. % protein on a dry solids basis and the modified oilseed material has an MW50 of at least about 200 kDa and at least about 40 wt. % of the protein in a 50 mg sample of the modified oilseed material is soluble in 1.0 mL water at 25° C.

U.S. Pat. No. 4,486,413 to Weisenberger, et. al., and assigned to Finna Peter Eckes, describe a protein-containing conditioning drink consisting essentially of 30 to 90 wt. % of a fruit juice or of a mixture of fruit juices having a solids content of 4 to 20 wt. %; 2 to wt.% of a whey concentrate corresponding to a whey protein content of 1.2 to 5 wt. % and a lactose content that is enzymatically cleaved; mineral salts and vitamins; and having a pH of 4.0 to 5.0.

U.S. Pat. No. 6,429,190 to Portman, Robert, and assigned to PacificHealth Laboratories Inc., describe a nutritional composition for adding to food for enhancing and extending the satiety of the food thereby aiding the user to lose weight, comprising long chain fatty acids (C12 to C18) being in the range of 1.0 to 6.0 grams by weight of said composition with a source of calcium being in the range of 1.0 to 4.0 grams by weight of said composition and potato fiber being in the range of 1.0 to 6.0 grams by weight bf said composition and a whey protein enriched with glycomacroprotein, said enriched whey protein being in the range of 1.0 to 5.0 grams by weight of said composition, a glucomannan fiber being in the range of 0.5 to 4.0 grams by weight of said composition with guar fiber being in the range of 1.0 to 4.0 grams by weight of said composition and alfalfa being in the range of 0.05 to 3.0 grams by weight of said composition wherein the total weight of said composition, including optional ingredients, being in the range of 5.55 to 32.0 grams.

U.S. Pat. No. 5,688,547 to Ritchey, et. al., and assigned to American Cyanamid Co., describe a dry, nutritional meal replacement composition comprising a cellulose gel and a cellulose gum, and nutritionally effective amounts of proteins, carbohydrates, dietary fiber, vitamins and minerals, wherein each serving provides about 6g of fiber, 16g of protein, about 31 g of carbohydrates and 220 calories after mixing with milk said composition being adapted to mix with a liquid to provide a drinkable beverage when mixed with low shear and a pudding when mixed with high shear.

U.S. Pat. No. 4,833,128 to Solomon et al discloses a dietary supplement for the oral administration of phenylalanine in conjunction with protein, carbohydrate and fat to stimulate satiety. This patent teaches that when a dietary supplement containing phenylalanine is consumed fifteen minutes prior to a meal, it generates a feeling of satiety resulting in less food consumption at the subsequent meal. The CCK release slows gastric emptying and the fiber in the invention provides an additional effect by slowing gastric emptying. The nutritional supplement in this patent contains 140 calories and it is recommended that it be taken three times a day. At a dose of three times a day, this dietary supplement would provide almost 25% of the total calories suggested in a reduced caloric program (1600 calories) to lose weight. Furthermore, the addition of phenylalanine limits its use in patients with phenylketonuria. Finally, the patent does not have any effect on extending the duration of action of CCK by inhibiting the action of trypsin and chymotrypsin on CCKRP by the addition of a proteinase inhibitor. In fact, the patent teaches that the appetite suppression of CCK may be merely temporary result in a limited satiety effect.

U.S. Pat. No. 5,739,106 to Rink discloses appetite regulating compositions. The patent discloses methods and compositions for reducing food intake, suppressing appetite and controlling body weight. These compositions may include an amylin agonist (amino acid protein hormone) and a CCK agonist or a hybrid peptide.

U.S. Pat. No. 5,849,708 to Maratos-Flier discloses a method for promoting eating, gaining weight or maintaining weight in a subject. The patent relates to the use of an effective amount of melanocyte concentrating hormone (MCH), MCH agonists and antagonists in regulating eating behavior.

### SUMMARY OF INVENTION

The invention is a protein rich, dry dietary supplement comprising a blend of legume protein, whey protein, egg white, calcium caseinate and non-fat dry milk. In the preferred embodiment, the protein blend is combined with additional nutrients, vitamins, minerals, and flavorings. The present formulations are designed to allow individuals that digest the protein rich formulations to control weight (increase, decrease, or maintain), as well as to optimize health by enhancing their immune system. A preferred feature of the invention comprises dry nutritional meal supplementation compositions comprising;

(A) a protein blend comprising protein concentrate including soy, whey, egg white, casein (in the form of calcium caseinate), and non fat dry milk, in an amount of about 1.0-95.0% by weight or at least 20 grams of protein in a 60 gram serving amount.

(B) a blend comprising a cellulose gum, including guar gum, safflower oil, xanthan gum (from algae) in an amount of about 1-95% by weight;

(C) a vitamin blend including at least vitamin A, vitamin D, vitamin K, all the essential B vitamins including vitamin B1, also known as thiamine, thiamin or aneurin, niacin or nicotinic acid, vitamin B2, also known as riboflavin, niacinamide, a water-soluble B-complex vitamin also known as niacin, or nicotinic acid, and commonly called Vitamin B-3, pantothenic acid or calcium pantothenate, also known as Vitamin B5, B6 vitamin known also as pyridoxine HCl, vitamin B9, also known as folic acid, vitamin B12 or cyanobalamin, as well as biotin (a B complex), vitamin C, and vitamin E, and lecithin, all in sufficient amounts such that at least 5% of the Daily Value based on a 2000 calorie diet is achieved.

(D) a mineral blend in various forms that includes calcium (in multiple forms), iodine, selenium, manganese, molybdenum, iron, phosphorus, magnesium, zinc, copper, and chromium all again in an amount of at least 5% of the Daily Value based on a 2000 calorie diet is achieved.

(E) a natural or an artificial sweetener or a mixture thereof in an amount of about 0.1-80.0% by weight;

(F) dietary fibers other than (B) in an amount of up to about 70% by weight including flax seed meal powder; and

(G) an effective amount of a flavoring agent, alone or in further combination with a coloring agent.

Also included in the present invention is a method for weight control comprising providing satiety, optimum health, and enhanced immune function support by mixing the composition as described above and combined with an ingestible liquid, e.g., milk, water, a flavored carbonated or still beverage, fruit or vegetable juice, or a mixture of any of the foregoing, and ingesting the same as a meal supplementation.

Accordingly, it is an object of the present invention to provide a nutritional composition that can be taken alone or added to different foods that will moderate weight, provide a satiation effect, enhance the immune system and generally optimize the health of an individual.

Another object of the present invention is to provide a nutritional and immune enhancing composition that can be taken alone or added to food that delivers a partial or total meal replacement of more than 100 calories in a calorically efficient manner using a high protein, low carbohydrate and fat content.

Another object of the present invention is to provide a nutritional composition that can be added to water, milk, soy milk or juice that delivers a total meal replacement of only 200-250 calories to cause e weight loss resulting from a reduced caloric intake.

Another object of the present invention is to provide a nutritional composition that can be added to water, milk, soy milk or juice that delivers a partial or total meal replacement of at least 100 calories to provide for weight loss, maintenance, or increase resulting from caloric intake that is palatable, well tolerated and without any unwanted or undesired side effects to individuals.

Another object of the present invention to provide a nutritional composition that can be added to different foods such as soups, cereals, yogurt and cookies to accomplish the foregoing objects:

Providing a universal protein formulation meeting multiple dietary needs for optimal health is a challenge which is difficult to meet. The formulation of the present invention, however, addresses this challenge and need with the understanding that each individual's exact nutritional requirements are different and that each individual's needs change during the course of a lifetime. A common goal is to assist individuals with boosting immune system response and functionality, which the present formulation is also designed to accomplish by providing a full range of protein, vitamins, and minerals for meal supplementation or even possibly meal replacement.

### DETAILED DESCRIPTION OF THE INVENTION

The invention is a protein rich, dry dietary supplement comprising a blend of legume protein (including soy protein isolate) whey protein concentrate, egg white, calcium caseinate, and non-fat dried milk. In the preferred embodiment, the protein blend is combined with fructose, flaxseed meal powder, safflower oil, natural and artificial flavor, guar gum, cellulose gum, lecithin, sodium chloride, xanthan, acesulfame-K, sucralose, silicon dioxide, vitamin palmitate (vitamin A), ascorbic acid (vitamin D), dicalcium phosphate, cholecalciferol (vitamin D), vitamin E acetate, phytomenadione (vitamin K1), Vitamin B1, also known as thiamine or thiamine mononitrate, thiamin or aneurin, niacin or nicotinic acid, Vitamin B2, also known as riboflavin, niacinamide, a water-soluble B-complex vitamin also known as niacin, or nicotinic acid, and commonly called Vitamin B-3, pantothenic acid or calcium pantothenate, also known as Vitamin B5, B6 vitamin known also as pyridoxine HCl, vitamin B9, also known as folic acid, vitamin B12, lecithin, cyanocobalamin, calcium pantothenate, potassium iodide, magnesium oxide, dimagnesium phosphate, zinc oxide, selenium amino acid chelate, copper gluconate, manganese sulfate, chromium amino acid chelate, molybdenum amino acid chelate. Additional flavorings and colorings may be added in either the dry powder or liquid form. For completeness, U.S. patents and applications 6,468,962, 6,558,690, 6,429,190, 6,811,804, 6,716,815, 6,572,876, 6,497,906, 5,688,547, 6,811,798, 6,207,638, 2001/0021694 A1, and 6,455,095 are hereby incorporated by reference. A detailed list of the nutritional value of the protein rich supplement is detailed below;

Nutritional Contents of Preferred Embodiment

Calories-230

If used with a 60 gram (2 rounded scoops) serving

Calories from fat-45

| | % daily value |
|---|---|
| Total Fat - 5 g | 8% |
| Saturated fat | 10% |
| Cholesterol 30 mg | 10% |
| Sodium 300 mg | 12% |
| Potassium 350 mg | 10% |
| Total Carbohydrate 12 g | 4% |
| Dietary fiber 2 g | 8% |
| Sugars 7 g | |
| Protein 34 g | |
| Vitamin A | 35% |
| Calcium | 60% |
| Vitamin D | 35% |
| Riboflavin | 35% |
| Vitamin B6 | 35% |
| Vitamin B12 | 35% |
| Vitamin C | 35% |
| Iron | 20% |
| Vitamin E | 35% |
| Niacin | 35% |
| Folic Acid | 35% |
| Biotin | 35% |
| Pantothenic Acid | 35% |
| Iodine | 35% |
| Selenium | 35% |
| Manganese | 35% |
| Molybdenum | 35% |
| Phosphorous | 45% |
| Magnesium | 35% |
| Zinc | 35% |
| Copper | 35% |
| Chromium | 35% |

The percent daily value and the recommended daily allowances are specified below to further define the nutritional values associated with the preferred embodiment of the present invention and the formulation listed above. Recommended Dietary Allowances (RDAs) are the amount of vitamins and minerals needed to provide for adequate nutrition in most healthy persons. RDAs for a given nutrient may vary depending on a person's age, sex, and physical condition (e.g., pregnancy).

Daily Values (DVs) are used on food and dietary supplement labels to indicate the percent of the recommended daily amount of each nutrient that a serving provides. DV replaces the previous designation of United States Recommended Daily Allowances (USRDAs).

All components of the present powdered composition provide specific and in many cases synergistic beneficial effects regarding weight maintenance and optimal health using immune function enhancement when consumed by humans. The specific components which have been included in the preferred embodiments are described separately below and have been developed from the knowledge and understanding associated with and described in the “Background of the Invention” section above.

The above active ingredients can be combined with other food products to make a meal replacement product. Preferably, the caloric total has a range of 200-250 calories. For example, if the active ingredients are added to other ingredients, as shown in Table 2, one example of a meal replacement product would have the ingredients as shown in Table 3.

However, the above active ingredients can be combined with other ingredients to make a meal replacement product.

The active ingredients of Table 6 can be combined with any food product such as yogurt, gelatin dessert, apple sauce, cottage cheese, cereal, bread, soup, protein bars, fruit shakes, candy bars, etc. to produce foods of varying caloric totals to assist with ingestion such that optimal health ingestion occurs with all the added benefits of immune enhancement.

The nutritional formulation may be added to drinks selected from the group consisting of apple juice, orange juice, grape juice, grapefruit juice, cranberry juice, coffee, tea, milk, milkshakes, broth, and soup consommé.

Other additives can be used in conjunction with the active ingredients of Table 1, for aiding the user to lose weight. Such additive ingredients may include caffeine in the range of 25 to 200 mg by weight of the composition, chromium picolonate and/or hydroxy citrate.

Proteins

The special protein blend of the present invention includes egg whites. The traditional nutritional dogma is that raw egg whites contain a glycoprotein known as avidin, which is very effective at binding biotin, one of the B vitamins. One concern has been that the use of egg whites can lead to a biotin deficiency. The simple solution is to cook the egg whites as this completely deactivates the avidin. The other solution is to include biotin as an active component of the food source, as is also accomplished by the present invention. In addition, several values are commonly used to measure protein quality and these have already been described in detail. Protein Digestibility Corrected Amino Acid Score (PDCAA) and the scoring method provided in the Background of the Invention section above have been determined to be the most valuable in determining which protein source is best for optimal health and nutrition as well as providing the best biological value (BV). Biological value measures the amount of protein retained from the absorbed rotein, which is essential in providing optimal health as well as assisting with proper weight control. Egg protein scores 100 on the biological value, meaning all ingested egg protein is retained (used) by the body (egg protein contains all the essential amino acids needed by the body). Another protein which scores 100 on the biological value score is whey protein—another component of the protein blend of the present invention.

The PDCAA score measures the “completeness” of a protein. The scoring of 1.0 is the highest measure. Egg whites, along with soy protein isolates, whey protein, and casein protein all score 1.0 on this scale. Whey protein actually scores higher than 1.0 at 1.14, but is reported as 1.0. The present formulation protein blend, therefore, combines all the proven most digestible and retainable proteins, thus allowing for optimal health and sustained satiety, a key requirement in weight loss, retention, or gain, as desired by the individual that consumes the powdered formulation in either solid or liquid form.

In addition, egg whites have additional nutritional value not associated with other forms of protein. Specifically, egg whites contain almost no fat and absolutely no cholesterol. The small amount of unsaturated fats from egg yokes are generally considered beneficial to health. The present invention allows for the use of egg whites as the sole source of protein to ensure that, if desired, no saturated fats are incorporated in the formulation. Other protein blends free of or low in saturated fats exist, but not in combination with the additional beneficial ingredients listed below. The addition of non fat dry milk is optional and complements the use of egg white as a complete protein. The need for complete proteins have been previously described and includes the full spectrum of amino acids as well as biopeptides to assure full utilization within the human cellular structure(s). Calcium (which as a protein is present in the form of calcium caseinate) has been shown to stimulate CCK release through a different mechanism than the other CCK stimulating agents in this invention. Long chain fatty acids are also potent releasers of cholecystokinin. The most effective fatty acids are those between C12-C18 in length.

Sweeteners

The use of acesulfame K as a sweetener is also included with the special protein blend. Acesulfame is not metabolized and therefore it contributes no calories to the powdered mix. By substituting acesulfame K for sugar in foods and beverages, calories can be reduced substantially, or, in some products, practically eliminated. The sweet taste of acesulfame K remains unchanged during baking. Even at oven temperatures over 200° C., acesulfame K shows no indications of breaking down or losing its sweet taste. Beverages containing acesulfame K also can be pasteurized under normal pasteurizing conditions without the loss of sweetness. Acesulfame K has a high degree of stability over a wide range of pH and temperature storage conditions. Acesulfame K has a clean, quickly perceptible sweet taste that does not linger. Acesulfame K generally does not exhibit any off-taste in foods and soft drinks. In addition, Acesulfame K can provide a synergistic sweetening effect when combined with other non-nutritive sweeteners. Acesulfame K does not contribute to dental cavities. Studies have shown that acesulfame K has no effect on serum glucose, cholesterol, or triglycerides. People with diabetes may incorporate products containing acesulfame K into their balanced diet. More than 90 studies have demonstrated the safety of acesulfame K. The U.S. Food and Drug Administration permitted the use of acesulfame K after evaluating numerous studies and determining it is safe for its intended use. The FDA approved acesulfame K for use in liquid non-alcoholic beverages (soft drinks) on Jul. 6, 1998. FDA has reaffirmed acesulfame K's safety on nine separate occasions by broadening its approval. A general use approval was grated by the FDA in December of 2003. The Joint Expert Committee on Food Additives (JECFA), the scientific advisory body to the World Health Organization and the Food and Agriculture Organization of the United Nations, reviewed the available research on acesulfame K and concluded that it is safe. JECFA has also established an ADI of 15mg/kg of body weight. The Scientific Committee for Food of the European Union published a comprehensive assessment of sweetening agents in 1985. This committee of toxicological experts from the EU member countries accepted acesulfame K for use in foods and beverages. Acesulfame K has been used in Europe since 1983, and in the U.S. since 1988, with no known documented adverse health effects. Americans and humans on other parts planet Earth continually are searching for good-tasting, low-calorie products to consume as part of an overall healthy lifestyle. Recent surveys continue to show that calorie-conscious consumers want additional low-calorie foods and beverages. The development and approval of a variety of safe low-calorie sweeteners, fat substitutes and other low-calorie ingredients is helping to meet this demand. The availability of several low-calorie ingredients allows food manufacturers to choose the most appropriate ingredient, or combination of ingredients, for a given product. When acesulfame K is combined with other low-calorie sweeteners, they enhance each other so that the combinations are sweeter than the sum of the individual sweeteners with significantly improved taste profiles. The combination of sweeteners of the present invention includes acesulfame K and fructose (naturally occurring sweetener from fruits and vegetables), and sucralose (a no calorie sweetener derived directly from sucrose). Sucralose is the low-calorie sweetener made from table sugar or sucrose, but is about 600 times sweeter than sugar and can be used in place of sugar to eliminate or reduce calories in a wide variety of products, including that of the present inventive composition. Sucralose was discovered in 1976 and more than 100 scientific studies conducted over a 20-year period have conclusively demonstrated that sucralose is safe for consumption. Sucralose is derived from sucrose (table sugar) through a patented, multi-step process that selectively substitutes three chlorine atoms for three hydrogen-oxygen groups on the sucrose molecule. Sucralose prevents the (negative) impact on blood sugar and insulin that sucrose causes because the tightly bound chlorine atoms create a molecular structure that is exceptionally stable and also because the body does not recognize sucralose as a carbohydrate and therefore simply eliminates it without digesting the substance.

The combination of these sweeteners and other low calories artificial or earth grown sweetener derivatives may be used in combination with the other ingredients comprising the present powdered mix. Use of the acesulfame K provides synergy and enhancement and is therefore a preferred but not a required ingredient of the present invention.

Vitamins and Vitamin Supplements

The primary vitamins are normally identified as vitamin A, D, E, K, C, and B complex. Of these, A, D, E, and K are the fat soluble vitamins. Vitamins C and B complex are water soluble. The fat soluble vitamins are commonly stored in special fat storage cells called lipocytes, whereas, the water soluble vitamins are not stored within the body except in small amounts. It is for this reason that the fat soluble vitamins pose the biggest threat if over supplemented. They are stored and build up within the body.

The body tissues do not readily store water soluble vitamins and when fed in excess, they are easily eliminated from the body via the urine. Because water soluble vitamins do not accumulate within the tissues, there is minimal risk of toxic effects. All of the water soluble vitamins, just as the fat soluble ones, are inherently important for life. The lack of adequate amounts of vitamins has been well described in both animals and people. It is known that the immune system functionality is highly dependent on the provision of vitamins.

Vitamin A or “vitamin palmitate” plays a critical role in the body. It helps prevent night blindness, promotes growth and is needed for healthy skin. This vitamin is used to prevent and treat a vitamin A deficiency which occurs in both adults and children. Vitamin A accumulates in body-fat (fat-soluble), and therefore too much vitamin A can cause serious side effects (e.g., liver damage).

The need for vitamin B and the B complex Biotin was elucidated above based on the use of egg white as a protein source. Additional B vitamins are desirous for maintaining good health and ensuring proper cellular differentiation, transmission of nerve electricity, health of nerve cells, heart pulse rate, muscular contraction, digestion, brain function, thought processes and energy production. The unique combination of proteins, sweeteners, and vitamins included in the dry powdered mix of the present invention includes all of the vitamin B complex and water soluble B vitamin indicated below, but may also be specifically formulated to include only specific B vitamins for specific health related purposes. B vitamins help the body to convert carbohydrates into glucose (sugar), which is “burned” to produce energy. These B vitamins, often referred to as B complex vitamins, are essential in the breakdown of fats and protein. B complex vitamins also play an important role in maintaining muscle tone along the lining of the digestive tract and promoting the health of the nervous system, skin, hair, eyes, mouth, and liver. All the B vitamins should be taken together to prevent deficiency symptoms developing. Apart from the B complex vitamins, there are also other important co-nutrients that should be taken including manganese, zinc, and vitamin C (in the form of ascorbic acid in the present formulation).

Vitamin B₁ is also known as thiamine, thiamin and aneurin. Thiamine is the currently accepted name for vitamin B₁ in the U.S. Aneurin is still widely used in Europe, especially in the United Kingdom. The chemical name for this water soluble vitamin is 3-[(4-amino-2-methyl-5-pyrimidinyl) methyl]-5-(2-hydroxyethyl)-4-methylthiazolium. Thiamine is a coenzyme for the decarboxylation of pyruvate and the oxidation of alpha keto-glutamic acid. Lipoic acid which is formed in the liver is also required for the reactions. Patients with liver disease may show signs of B1 deficiency, possibly because of deficient synthesis of lipoic acid. In vitro, thiamine deficiency produces accumulation of pyruvate and lactate, reduction of acetate, citrate and alpha-keto-glutarate and reduced acetylcholine synthesis. Any of these metabolic changes could be involved in dysfunction. The use of vitamin B₁ is essential for converting carbohydrates into energy with the human system.

Vitamin B2, also known as riboflavin is required by the body to use oxygen and the metabolism of amino acids, fatty acids, and carbohydrates. Riboflavin is further needed to activate vitamin B6 (pyridoxine), helps to create niacin and assists the adrenal gland. It may be used for red blood cell formation, antibody production, cell respiration, and growth. It eases watery eye fatigue and may be helpful in the prevention and treatment of cataracts. Vitamin B2 is required for the health of the mucus membranes in the digestive tract and helps with the absorption of iron and vitamin B6. Although it is needed for periods of rapid growth, it is also needed when protein intake is high, and is most beneficial to the skin, hair and nails. Deficiency of vitamin B2 is indicated by manifestation of cracks and sores at the corners of the mouth, eye disorders, inflammation of the mouth and tongue, and skin lesions. Dermatitis, dizziness, hair loss, insomnia, light sensitivity, poor digestion, retarded growth, and slow mental responses have also been reported.

Niacinamide is another of the water-soluble B-complex vitamins. Niacin, or nicotinic acid, is also known as Vitamin B-3. When an amide molecule attaches itself to niacin, it becomes niacinamide—the water soluble form. One major difference regarding digestion and consumption is that in doses exceeding 50 mg, niacin typically produces flushing of the skin. Niacin and niacinamide also have different applications. In its niacinamide form, it is useful in arthritis and early-onset type I diabetes, whereas niacin is an effective reducer of high cholesterol levels. There is also evidence that niacinamide increases energy and alertness.

Niacinamide was first linked to preventing the development of diabetes in experimental animals in the 1950s, a finding confirmed in the 1980s which led to further clinical studies. Niacinamide enhances insulin secretion and increases insulin sensitivity.

Evidence points to niacinamide supplements being very effective in preventing type I diabetes from progressing in some patients if given soon enough at the onset of diabetes. It does so primarily by helping restore beta cells.

Several studies performed on high-risk groups led to a larger population-based study conducted in New Zealand to see if niacinamide supplements can prevent diabetes from developing in high risk groups. The results of screening 32,000 five- to seven-year-old children for islet cell antibodies and treating those at risk proved quite impressive. Treating diabetes is very costly, but early intervention by screening (as done in the New Zealand study) and treating with niacinamide supplements could dramatically cut health-care costs.

Evidence on the impact of niacinamide on arthritis is only preliminary. Drs. William Kaufinan and Abram Hoffer have reported positive clinical results in the treatment of hundreds of patients with osteoarthritis and rheumatoid arthritis using high doses of niacinamide. These results have yet to be fully evaluated in detailed clinical studies. Pantothenic acid or calcium pantothenate is also known as Vitamin B5. This is also a water soluble vitamin found in the cellular structure. Vitamin B5 is produced in the intestines by bacteria and is known to place a role in preventing depression. Unfortunately, Vitamin B5 is lost in cooking water and is destroyed by heat of freezing. Acids and alkalis such as vinegar and baking soda also destroy this vitamin. Vitamin B5 is necessary for the release of energy from carbohydrates, the synthesis and degradation of fatty acids and other acetylation reactions. This vitamin is also required for the production of steroid hormones, the adrenal glands'production of hormones and nervous system function. Therefore, as described below, it assists with the use of use of cholecalciferol. Vitamin B5 is required to gain resistance to stress, shock and allergies, plus protection against radiation-caused cellular damage. Vitamin B5 has other uses including being required for carbohydrate, fat and protein metabolism, cholesterol and fatty acids, skin health, and decreasing the side effects of certain drugs. Significant food sources that contain vitamin B5 are egg yolks, milk, yoghurt, cheese, wheat germ, nuts and whole grains. Suffering from stress, allergies or strenuous activity increases the requirements for vitamin B5. Also requirements of vitamin B5 may need to be increased if taking certain drugs such as aspirin, diuretics, antibiotics, antacids and sleeping tablets are taken. There are no known toxic effects with low to moderate levels of vitamin B5 intake.

B6 vitamin known also as Pyridoxine HCl, is essential for amino acid absorption, metabolism, and transport, the formation and growth of red blood cells, and for the utilization of many substances used by the nervous system. B6 is involved in more bodily functions than almost any other single nutrient. It affects both physical and mental health, and is necessary for the production of hydrochloric acid and the absorption of fats and protein. Pyridoxine also aids in maintaining sodium and potassium balance and promotes red blood cell formation. It is required by the nervous system for normal brain function, for the synthesis of RNA and DNA, which contain the genetic instructions for the reproduction of all cells and for normal cellular growth. It activates many enzymes and aids in the absorption of vitamin B12, in immune system function, and in antibody production. A deficiency of vitamin B6 is associated with irritability, weakness and nervousness.

Vitamin B9, also known as folic acid or folate, is also one of the eight water-soluble B vitamins found in the present formulation on (B1, B2, B3, B5, B6, B9, B12 and Biotin).

Folic acid is crucial for proper brain function and plays an important role in mental and emotional health. It aids in the production of DNA and RNA, the body's genetic material, and is especially important during periods of high growth, such as infancy, adolescence and pregnancy. Folic acid also works closely together with vitamin B12 to regulate the formation of red blood cells and to help iron function properly in the body.

Vitamin B9 works closely with vitamins B6 and B12 as well as the nutrients betaine and S-adenosylmethionine (SAMe) to control blood levels of the amino acid homocysteine.

Elevated levels of this substance appear to be linked to certain chronic conditions such as heart disease and, possibly, depression and Alzheimer's disease. Some researchers have even speculated that there is a connection between high levels of this amino acid and cervical cancer, but the results of studies regarding this speculation have been inconclusive.

Folic acid deficiency is the most common B vitamin deficiency. Animal foods, with the exception of liver, are poor sources of folic acid. Plant sources rich in folic acid are frequently not obtained in adequate amounts in the diet. Alcoholism, irritable bowel syndrome, and celiac disease contribute to deficiency of this important nutrient. Folic acid deficiency can cause poor growth, tongue inflammation, gingivitis, loss of appetite, shortness of breath, diarrhea, irritability, forgetfulness, and mental sluggishness.

Vitamin B12 is also member of the B-complex of vitamins, normally needed in only minute amounts It is necessary for the formation and regeneration of red blood cells thereby preventing anemia. B12 promotes growth and increases appetite and energy in children and helps maintain a healthy nervous system. Many elderly people suffering from neurological impairment find that B12 supplementation greatly improves their cognitive function. Published studies show that vitamin B12 in supplement form is absorbed better by elderly people than vitamin B12 that is bound to food. Vitamin B12 is only found in animal source foods and is often deficient in vegetarian diets. Cyanocobalamin is a synthetic and inexpensive form of vitamin B12 that is easily converted in the body to its bioactive forms, methylcobalamin and cobamamide.

Biotin is also known as vitamin H and coenzyme R (Hexahydro-2-oxo-1H-thienal [3,4-d]-imidazole-4-pentatonic acid). It is found primarily in liver, kidney and muscle. Biotin functions as an essential cofactor for four carboxylases that catalyze the incorporation of cellular bicarbonate into the carbon backbone of organic compounds. Acetyl-CoA carboxylase (ACC) is located in the cytosol where it catalyzes the formation of malonyl-CoA which then serves as a substrate for fatty acid elongation. The other three enzymes are located in the mitochondria. Pyruvate carboxylase (PC) catalyzes the incorporation of bicarbonate into pyruvate to form oxaloacetate, an intermediate in the tricarboxylic acid cycle. In gluconeogenic tissues such as the liver and kidney, oxaloacetate can be converted to glucose. Methcrotonyl-CoA carboxylase (MCC) catalyzes the incorporation of bicarbonate into propionyl-CoA to form methylmalonyl-CoA which, in turn, is metabolized to other compounds that eventually enter the tricarboxylic acid cycle.

Vitamin C or ascorbic acid has numerous benefits that have been well documented by numerous scientists and medical doctors and most recently touted by Linus Pauling and his associates. There seems to be no deleterious health risks associated with the addition of vitamin C in any soluble form. Benefits associated with vitamin C include; aiding in fighting off foreign invaders, it is vital to the production of collagen, which is involved in the building and health of cartilage, joints, skin, and blood vessels. Vitamin C helps protect the fat-soluble vitamins A and E as well as fatty acids from oxidation. It aids in neutralizing pollutants. It is needed for antibody production. It has natural antihistamine properties. One small study conducted at the Methodist Hospital in Brooklyn, N.Y. found significant reductions in blood levels of histamine after people took 1,000 milligrams of Vitamin C for three consecutive days.

An Italian study found that people with hay fever, who had taken 2,000 milligrams of Vitamin C daily, were better able to maintain the volume of air they could exhale.

Vitamin C may also help reduce some of the inflammation associated with chronic allergies, according to other studies. Additional studies have found that Vitamin C may contribute to healthy bones, help prevent periodontal disease, aid in healing wounds, combat inflammation and pain, aid iron absorption, break down histamine, and offer potent antioxidant protection, protect lung function and maintain cognition in the elderly.

The use of cholecalciferol in the present invention and formulation is to infuse vitamin D with the special absorbed protein blend into the bloodstream of the consumer. Unlike any other vitamin, vitamin D is actually a prehormone; it is your body's only source of a potent steroid hormone known as calcitriol. First, the skin makes vitamin D when sunlight strikes a precholesterol molecule. Then the liver converts vitamin D into the storage form of vitamin D, known as calcidiol (25-hydroxy vitamin D). The body stores calcidiol in the blood and fat for later use. Calcidiol can be measured in the blood to test for vitamin D deficiency. Ideal calcidiol (25-hydroxy vitamin D) levels are between 35 to 65 ng/ml (87 to 162 nm/L), year around for all humans. If there is sufficient calcidiol in the blood, biochemical reactions within the cells begin. Some calcidiol goes to the kidneys to help maintain blood calcium levels but cell tissue reactions convert calcidiol into calcitriol. Calcitriol, or activated vitamin D, is the most potent steroid hormone in the human body; it is active in picogram quantities or 1/1,000,000,000,000 of a gram. Like all steroid hormones, calcitriol works by turning genes on and off. For example, in hundreds of tissues throughout the body, calcitriol demasks the body's genome. When steroid hormone systems are turned on fill bore, without periodically turning off, this usually means the body requires more hormone. The calcitriol signals genes to make hundreds of enzymes and proteins crucial to maintaining health and fighting disease. Tissues may become starved for more of the potent steroid hormone in the body and this starvation can only be remedied enough vitamin D is received from sunshine or from supplements. For those avoiding the sun, recent research indicates the need for about 4,000 units of vitamin D per day. Individuals cannot get enough vitamin D from milk (unless they drink 40, 8oz. glasses a day) or from a multivitamin (unless you take about 10 tablets a day), neither of which is recommended. Therefore the need for a preferred supplement such as cholecalciferol.

Vitamin E or vitamin E acetate is, like vitamin C, a well documented beneficial vitamin for the human condition. Numerous preliminary and observational studies have looked at the role and benefits of Vitamin E supplements in heart disease. Some promising results, such as the Nurse Study in 1993 involving 90,000 nurses, associated Vitamin E supplements to lower rate of coronary heart disease by 30 -40%. Another observational study in Finland involving over 5000 people also suggested that Vitamin E supplements was associated with lower death rate from heart disease. Vitamin E is a fat-soluble vitamin. Vitamin E exists in various forms; alpha-tocopherol is the most active form of Vitamin E in humans. Alpha-tocopherol is a powerful antioxidant protecting from free radical damage. Free radical damage is often thought to contribute to the development of cancer and heart disease. Vitamin E can be found in vegetable oils, nuts, and green leafy vegetables

Vitamin K1 or phytomenadione (K1) is an oil purified from alfalfa concentrates and is mainly used as an antidote in warfarin (anti-clotting agent) overdose. Warfarin opposes or prevents the action of natural vitamin K and is therefore used to thin the blood and prevent blood clots forming in blood vessels. When too much warfarin is inadvertently given, it causes severe bleeding (hemorrhage) which can be life threatening.

Phytomenadione is therefore given to replace vitamin K rapidly in the liver. This speeds up the blood clotting process and prevents excessive bleeding for individuals with that need. The best naturally occurring sources are leafy green vegetables, such as cabbage and spinach, and intestinal bacteria (which produce most of the body's supply of vitamin K). The estimated safe and adequate intake for adults is 70 to 140 micrograms.

Other Additives

Lecithin is a fatlike substance known as a phospholipid. It is produced daily by the liver if the diet is adequate. It is needed by every cell in the body and is a key building block of cell membranes; without it, cell membranes would harden. Lecithin protects cells from oxidation and largely comprises the protective sheaths surrounding the brain. It is composed mostly of B vitamins, phosphoric acid, choline, linoleic acid and inositol.

Although it is a fatty substance, it is also a fat emulsifier. Hence, it supports the circulatory system. The choline in lecithin is useful for making acetylcholine. Most lecithin is derived from soybeans and it is easily blended with soy protein isolate as in the present formulation.

Manganese is essential for normal growth and health. For patients who are unable to get enough manganese in their regular diet or who have a need for more manganese, manganese supplements may be necessary. Manganese helps the human body break down fats, carbohydrates, and proteins during digestion by being incorporated with several enzymes. Although manganese deficiency has not been reported in human, lack of manganese in animals has been found to cause improper formation of bone and cartilage, decreases in the body's ability to use sugar properly, and may cause growth problems.

Potassium iodide is used primarily to treat overactive thyroid and to protect the thyroid gland from the effects of radiation from inhaled or swallowed radioactive iodine. It may be used before and after administration of medicine containing radioactive iodine or after accidental exposure to radioactive iodine (for example, from nuclear power plant accidents that involved release of radioactivity to the environment). Iodide also aids in the nutritive process, balances the general glandular system, assists with energy production, promotes growth and development, promotes the retention of color and texture of hair, and stimulates the circulatory system. Iodide is also essential for proper thyroid health and function and is also optimally used as part of the present formulation.

Magnesium aids in elimination of foreign matter and waste, helps with Albumen formation (a complex protein found in blood and muscle and associated with the egg white in the present composition's protein blend), builds cells, particularly lung and nervous tissue cells, assists with calcium and vitamin C metabolism is a constituent of muscle, gives strength to bone and teeth, regulates blood pH, and protects the arterial lining from stress by sudden blood pressure changes. It is found in the present formulation as magnesium oxide and dimagnesium phosphate which are easily digestible forms of the mineral.

Manganese is required for enzyme activation, fat, carbohydrate, and nucleic acid metabolism, sex hormone production, reproduction and growth, tissue respiration and tones ligaments. Manganese is essential for healthy pituitary gland, liver, pancreas, kidney, and bones and helpful for blood clotting, development of other connective tissues, and regulation of cholesterol synthesis. It helps in energy production, healthy nerves, healthy immune system and blood sugar regulation. Manganese is found to be naturally occurring in whole grains, cereal products, lettuce, dry beans, and peas. The present formulation involves the optional addition of manganese sulfate, which is a more easily digestible form of the mineral.

Amino acid chelated complex minerals are produced through patented technology and are the most readily usable form of minerals. Minerals in general help vitamins do their job.

Amino acid chelated minerals may help make vitamins more effective. Amino acid chelated minerals and complex minerals are the easiest for the body to absorb and use.

Minerals are recognized as vital nutritional components, since they must be present in order for all systems in the body to function properly.

Selenium amino acid complex helps enhance the immune system and acts as a powerful antioxidant. It protects against the toxic effects of cigarette smoke and heavy metal poisoning such as mercury and cadmium and also helps protect enzymes from free radical damage. Selenium in this form is easily digestible and provides for better pancreatic function and cell membrane integrity as well as protecting against the peroxidation of fats (additional free radical damage prevention).

Chelated copper gluconate is a readily absorbable form of copper often used in quality copper supplements including the formulation of the present invention. Copper is an essential trace mineral that is present in all body tissues. However, there are times when its concentration is higher than others. For example, during growth, copper will be more abundant in those developing tissues. Copper gluconate is one of the most important blood antioxidants and prevents the rancidity of poly-unsaturated fatty acids. It also helps keep cell membranes healthy and is active in the storage and release of iron to form hemoglobin for red blood cells. Copper gluconate also acts as an immune system booster, and help keep nerves and bones healthy. Other potential benefits of copper gluconate include: helping with high cholesterol, osteoporosis, wound healing, benign prostatic hyperplasia, cardiac arrhythmia, hypoglycemia, peripheral vascular disease, osteoarthritis, and rheumatoid arthritis. Copper can be toxic if taken in large excesses.

Average adults need about 2 mgs.

Chromium amino acid chelate assists with the metabolism of glucose, increases the effect of insulin, and stimulates synthesis of fatty acids. The chromium complex assists with the entire amino acid metabolism process.

Molybdenum amino acid chelate is required for the activity of enzymes that are responsible for the development of bones, liver, and kidneys. It detoxifies sulfites in the body, and helps convert nucleic acid to uric acid, a waste product eliminated in the urine. Other chelated complexes that could be used in the present formulation and eventually may be shown to be more desirable, but are not specifically included as part of the most recent formulation include;

Calcium amino acid chelate aids general mineral and vitamin metabolism, bone/tooth formation, clotting, nerve and muscle response. Calcium also promotes normal behavior and mental alertness and as described above is essential in the satiety issues regarding absorption and retention of protein in the cellular structure. Calcium is also involved with proper heart action, pH regulation and reduction of fatigue. Coffee, alcohol and smoking reduce calcium levels in the body and thus supplementation (as with this or any form of calcium) is beneficial to those individuals.

Iron amino acid chelate assists hemoglobin and red blood cell formation, is involved with healing and oxidation of vitamin C, is present in metabolic enzymes, protein metabolism, proper bone formation, RNA synthesis, skin and hair pigmentation, and synthesis of phospholipids.

Zinc amino acid chelate is involved in alcohol breakdown; carbohydrate assimilation, healing burns and wounds, maintenance of healthy tissue, (enhances cell division, repair and growth), normal prostate function, phosphorus and protein metabolism, reproductive organ growth and development, and helps synthesize RNA and DNA. The immune system acuity of taste and smell is affected by level of zinc in the system and zinc is needed for maintenance of proper vitamin E levels. Zinc is necessary for absorption and activity of vitamins, particularly the B-complex vitamins and is a constituent in over 25 enzymes involved in human digestion and metabolism.

Potassium buffered amino acid complex is important for a healthy nervous system and regular heart rhythm. It assists kidney function and is necessary for healthy adrenal glands as well as balancing acids, and counter balances sodium action. Potassium helps maintain slight alkaline pH of internal fluids and proper fluid balance and aids in the release of insulin from the pancreas assisting in conversion of glucose to glycogen. Potassium is needed for neuromuscular contractions and normal growth. Potassium iodide in the present formulation is another method of delivering the necessary potassium to the system.

Boron amino acid complex wasn't considered essential for a healthy diet until very recently. Researchers have discovered that getting enough boron can help regulate the body's use of calcium, phosphorus, and magnesium, and reduce the risk of osteoporosis. These researchers have also found that boron improves reflexes and mental alertness. Boron is part of the bone matrix, and helps build muscle and may help prevent or retard rheumatoid arthritis.

Vanadium amino acid chelate is required for normal growth. It is involved in helping to prevent cardiovascular disease, helps to lower serum cholesterol, and only recently researchers have begun to recognize the role that vanadium plays in overall nutrition. Recent research on the immune system has demonstrated the importance of vitamins A, C, and E and the minerals zinc and selenium. Vitamins A, C and E are important for the formation of white blood cells. Selenium stimulates formation of antibodies to combat viruses and bacteria. Zinc stimulates the “killer” cells that search out and destroy harmful viruses and bacteria.

### COMPARATIVE EXAMPLE 1

### Diet Powdered Drink Mix

A known formulation is that of U.S. Pat. No.6,455,095 assigned to ThermoBean L. P., wherein the underlying dietary practice is to provide a diet supplement with metabolic increasing stimulants such as caffeine and ephedra to suppress appetite and thereby allow for weight reduction.

The list of ingredients is given as;
1) Alpha Galactosidase 100-500 Gal. Units.
2) L-Methionine 100-500 mg. Racemic mixtures of methionine may also be employed at twice the dosage.
3) Naturally occurring ephedra alkaloids 15-25 mg.
4) Naturally occurring caffeine 75-200 mg.
5) Medium chain triglycerides 250-500 mg.
7) Flaxseed powder 100-250 mg. Alternatively, flaxseed oil or other omega-3 fatty acid sources such as walnut, canola and soybean may be used. Fish oil is another source, but may detract from the flavor. Large amounts of flax seed may also detract from the flavor of the final product and are preferably avoided. Additional bulk may be additionally provided by other bulking agents, such as psyllium, bran, guar gum and the like.
8) Chromium Picolinate 100-25 mcg. Alternatively, other sources of chromium may be used, provided they are nontoxic, digestible and palatable.
9) Grape Seed Extract 10-100 mg.
10) Green Tea Extract 40-250 mg.
11) Vitamin B6 (Pyridoxine) 50-100 mg.
12) Vitamin B12 20-100 mcg
13) Folic Acid 100-400 mcg
14) Vitamin C 50-250 mg. Vitamins may be obtained from any convenient source, includin natural extracts, and any biochemically effective is acceptable.
15) Spices—Added to taste. Formulation may vary to provide a spice suitable for a particular legume preparation style.

### COMPARATIVE EXAMPLE 2

### Cholesterol Lowering Powdered Drink Mix

Another example of protein powders used to formulate liquid shakes includes U.S. Pat. No. 6,572,876 assigned to Solae, LLC, which provides for a dietary supplement with isoflavones for promoting reduction of LDL cholesterol.

One of the products described in the patent includes hard gelatin capsules that are prepared using the following ingredients: Isoflavone 25-100 mg/capsule; plant sterol 500-2000 mg/capsule; Starch, NF 0-1000 mg/capsule; starch flowable powder 0-1000 mg/capsule; silicone fluid (350 centistokes) 0-20 mg/capsule. The capsules are provides by mixing the ingredients, passing them through a sieve, and filling into the gelatin capsules.

Several U.S. Patents; No. 6,544,566, assigned to Protein Technologies International Inc., U.S. Pat. No. 6,497,906, assigned to Novagen Research, U.S. Pat. No. 6,630,178, assigned to NutraPharma Asa, describe the requirement for at least one isoflavone or phytoestrogen to be present in the formulation.

### COMPARATIVE EXAMPLE 3

### Satiety Powdered Drink Mix

U.S. Pat. No.6,429,190, assigned to PacificHealth Laboratories, Inc. describes a formulation for a nutritional composition for adding to food for enhancing and extending the satiety of the food by stimulating cholecystokinin (CCK) peptide. CCK also acts on vagal neurons leading back to the medulla oblongata which give a satiety signal (i.e., “that's enough food for now”). In a satiety study cited as [Holt, S. H., Miller, J. C., Petocz, P., Fannakalidis, E. (Department of Biochemistry, University of Sydney, Australia.) “A satiety index of common foods.” European Journal of Clinical Nutrition, Volume 49, September 1995, pages 675-690] potatoes scored the highest in feeling of fullness per caloric count. U.S. Pat. No.6,429,190 includes potato fiber content to induce satiety whereas the present invention does not include potato fiber. The complete list of ingredients is provided in Table 7 below;

TABLE 7
(Example 3)

| | |
|---|---|
| Active | Range (gms) |

| Ingredients | g/serv | Percent |
|---|---|---|
| Oleic acid | 4.00 | 25.05 |
| Calcium source | 2.80 | 17.53 |
| Potato Fiber | 3.00 | 18.79 |
| Whey protein | 2.81 | 17.60 |
| enriched with | | |
| glycomacro- | | |
| peptide | | |
| Glucomannan | 1.00 | 6.26 |
| Fiber | | |
| Guar Gum | 2.26 | 14.15 |
| (regular and | | |
| hydrolyzed) | | |
| Alfalfa Herb | 0.10 | 0.62 |
| Powder | | |
| TOTAL Active | 15.97 | 100.00 |
| Ingredients | | |

One product being produced and by Pacific Laboratories as of May 5, 2005 is shown below:

Supplement Facts
Serving Size: 26.6 grams
Servings Per Container: 1

| | | With 10 fl. oz. |
|---|---|---|
| Amount Per Serving | Shake Mix | Skim Milk |
| Calories | 110 | 220 |
| Calories From Fat | 40 | 45 |
| | % Daily Value | % Daily Value |
| Total Fat 4.5 g | 7% | 8% |
| Saturated Fat 0.5 g | 3% | 5% |
| Cholesterol 0 mg | 0% | 2% |
| Sodium 38 mg | 2% | 8% |
| Total Carbohydrate 10 g | 3% | 8% |
| Dietary Fiber 5 g | 19% | 19% |
| Sugars 1 g | | |
| Protein 7 g | 14% | 34% |
| Vitamin A 1000 IU | 20% | 35% |
| Vitamin C 18 mg | 30% | 35% |
| Calcium 161 mg | 15% | 50% |
| Iron 3.7 mg | 20% | 20% |
| Vitamin D 80 IU | 20% | 50% |
| Vitamin E 8.2 IU | 25% | 30% |
| Vitamin K 16.0 mcg | 20% | 35% |
| Thiamine 0.3 mg | 20% | 30% |
| Riboflavin 0.2 mg | 10% | 35% |
| Niacin 4.0 mg | 20% | 20% |
| Vitamin B₆ 0.4 mg | 20% | 25% |
| Folate 80.5 mcg | 20% | 25% |
| Vitamin B₁₂ 1.2 mcg | 20% | 40% |
| Biotin 60.0 mcg | 20% | 20% |
| Pantothenic Acid 2.0 mg | 20% | 30% |
| Phosphorus 38.3 mg | 4% | 35% |
| Iodine 15.2 mcg | 10% | 35% |
| Magnesium 71.6 mg | 20% | 25% |
| Zinc 3.1 mg | 20% | 30% |
| Selenium 14.0 mcg | 20% | 30% |
| Copper 0 mg | 0% | 2% |
| Manganese 0.4 mg | 20% | 20% |
| Chromium 24.0 mcg | 20% | 20% |
| Molybdenum 15.0 mcg | 20% | 30% |
| Chloride 3.0 mg | 0% | 10% |
| Potassium 117.7 mg | 4% | 20% |

*Percent Daily Values are based on a 2,000 calorie diet.

Ingredients: Sunflower oil, calcium caseinate, potato fiber, rice starch, corn syrup solids, whey protein concentrate enriched with glycomacropeptides, guar gum, konjac flour, nonfat milk powder, calcium lactate, natural and artificial flavor, contains two percent or less of soy lecithin, alfalfa powder, mono-and diglycerides, aspartame, acesulfame potassium, dipotassium phosphate, sodium silicoaluminate, magnesium oxide, maltodextrin, ferrous gluconate, ascorbic acid, d,l-alpha tocopheryl acetate, niacinamide, zinc oxide, manganese gluconate, d-calcium pantothenate, vitamin A acetate, pyridoxine hydrochloride, thiamine hydrochloride, riboflavin, folic acid, biotin, chromium chloride, potassium iodide, phytonadione, sodium molybdate, sodium selenate, cholecalciferol, cyanocobalamin.

### WORKING EXAMPLE 1

The present invention teaches away from stimulants such as caffeine, ephedra, etc. to increase metabolic rate and therefore calorie burn rate. The present invention also teaches away from isoflavones and phytoestrogen supplements beyond those found naturally in soy protein isolate. The present invention also teaches away from the use of potato or potato starch, as simply increasing the level of satiety is not the sole goal of the present formulation (potatoes were found to be highest on the satiety index). The present invention emphasizes the need and use of a proper protein food class supplement or potential meal replacement that must provide a superb amino acid profile to support optimal blood lipid profile balance and should include at least egg whites, soy, whey, casein, and milk protein and optionally include fish as well as vegetable mixed proteins to achieve ultimate health benefits and increase immune system enhancement. The protein in tuna contains all essential amino acids required by the body for growth and maintenance of lean muscle tissue. The protein in tuna and all other fish protein are considered to be a complete protein source. Based on the foregoing discussion regarding an equal rating methodology (ERM), the top four protein sources are egg whites, soy, whey and milk, each of which are included in the present formulation with fish and mixed vegetable proteins optionally added to the present formulation or provided before, during, or after the consumption of the formulation in the form of actual earth grown fish and/or vegetables.

For comparative example 1, the preferred embodiment includes the aforementioned protein blend that is combined with fructose, flaxseed meal powder, safflower oil, natural and artificial flavor, guar gum, cellulose gum, lecithin, sodium chloride, xanthan, acesulfame-K, sucralose, silicon dioxide, vitamin palmitate (vitamin A), ascorbic acid (vitamin D), dicalcium phosphate, cholecalciferol (vitamin D), vitamin E acetate, phytomenadione (vitamin K1), Vitamin B1, also known as thiamine or thiamine mononitrate, thiamin or aneurin, niacin or nicotinic acid, Vitamin B2, also known as riboflavin, niacinamide, a water-soluble B-complex vitamin also known as niacin, or nicotinic acid, and commonly called Vitamin B-3, pantothenic acid or calcium pantothenate, also known as Vitamin B5, B6 vitamin known also as pyridoxine HCl, vitamin B9, also known as folic acid, vitamin B12, lecithin, cyanocobalamin, calcium pantothenate, potassium iodide, magnesium oxide, dimagnesium phosphate, zinc oxide, selenium amino acid chelate, copper gluconate, manganese sulfate, chromium amino acid chelate, molybdenum amino acid chelate. Additional flavorings and colorings may be added in either the dry powder or liquid form. The specific supplement facts of the preferred embodiment of the present formulation in powdered product form to achieve a liquid mix is listed below;

Supplement Facts
Serving Size: 62 grams
Servings Per Container: 9

| Amount Per Serving | Liquid Mix |
|---|---|
| Calories | 240 |
| Calories From Fat | 45 |
| | % Daily Value |
| Total Fat 5.0 g | 8% |
| Saturated Fat 2 g | 10% |
| Cholesterol 30 mg | 10% |
| Sodium 300 mg | 12% |
| Potassium 450 mg | 13% |
| Total Carbohydrate 14 g | 5% |
| Dietary Fiber 3 g | 12% |
| Sugars 7 g | |
| Protein 34 g | |
| Vitamin A | 35% |
| Vitamin C | 35% |
| Calcium | 60% |
| Iron | 20% |
| Vitamin D | 35% |
| Vitamin E | 35% |
| Vitamin K | 35% |
| Thiamine | 35% |
| Riboflavin | 35% |
| Niacin | 35% |
| Vitamin B₆ | 35% |
| Folic Acid | 35% |
| Vitamin B₁₂ | 35% |
| Biotin | 35% |
| Pantothenic Acid | 35% |
| Phosphorus | 45% |
| Iodine | 35% |
| Magnesium | 35% |
| Zinc | 35% |
| Selenium | 35% |
| Copper | 35% |
| Manganese | 35% |
| Chromium | 35% |
| Molybdenum | 35% |

*Percent Daily Values are based on a 2,000 calorie diet. Daily intake may vary.

Ingredients: A protein blend of soy protein, whey protein, egg white casein, and non fat dry milk, fructose, flaxseed meal powder, safflower oil, natural and artificial flavor, guar gum, cellulose gum, lecithin, sodium chloride, xanthan, acesulfame-K, sucralose, silicon dioxide, vitamin palmitate (vitamin A), ascorbic acid (vitamin D), dicalcium phosphate, cholecalciferol (vitamin D), vitamin E acetate, phytomenadione (vitamin K1), Vitamin B1, also known as thiamine or thiamine mononitrate, thiamin or aneurin, Vitamin B2, also known as riboflavin, niacinamide, a water-soluble B-complex vitamin also known as niacin, or nicotinic acid, and commonly called Vitamin B-3, pantothenic acid or calcium pantothenate, also known as Vitamin B5, B6 vitamin known also as pyridoxine HCl, vitamin B9, also known as folic acid or folate, vitamin B12, lecithin, cyanocobalamin, calcium pantothenate, potassium iodide, magnesium oxide, dimagnesium phosphate, zinc oxide, selenium amino acid chelate, copper gluconate, manganese sulfate, chromium amino acid chelate, molybdenum amino acid chelate. Additional flavorings and colorings may be added in either the dry powder or liquid form.

One suggested supplemental or meal replacement method of enhancing immune system support and optimizing health for individuals using the formulation of the present invention is included below;

In a standard blender combine the following:
a). 6 -8 -10 ounces of distilled water
b). two tablespoons of natural, non-pasteurized apple cider vinegar—recommended is the natural apple cider vinegar distributed by Bragg. Vinegar is very important because it aids in digestion. This is especially beneficial for older people who have decreased hydrochloric acid in their stomach.
c). one tablespoon safflower oil—optional as the present formulation includes safflower oil which is a rich source of Omega 6 and can aid in reducing cholesterol, increasing HDL lipids in the body, and lowering the “bad” LDL lipids.
d). one tablespoon flaxseed or fish oil which contains EPA (eicosapentaenoic acid) and DHA docosahexaenoic acid), both omega-3 fatty acids. Most fish oil supplements are 18% EPA and 12% DHA, or a total of 30% omega-3. These omega-3 fatty acids, unlike the omega-3 fatty acid found in flaxseed oil and other vegetable oils (alpha linolenic acid), keep blood triglycerides in check (high triglycerides are generally linked with increased risk of heart disease) and may inhibit the progression of atherosclerosis. EPA and DHA keep blood from clotting too quickly. EPA and DHA also modulate immune function, probably as a result of their effect on prostaglandin production. Perhaps as a result of this effect, fish oil has helped prevent some types of cancer in animals and humans, although this evidence remains preliminary.
e). one scoop (31 grams) of the protein rich powdered formulation listed in comparative example 1
f). one teaspoon of glutamine powder—a white tasteless powder that speeds healing after surgery and has been shown to raise the production of human growth hormone levels. Glutamine is a pre-cursor to glutathione, which is an antioxidant.
g). one teaspoon of MSM powder (Methyl-Sulfonyl-Methane) that is a naturally occurring form of dietary sulfur found in fresh foods.
h). six to eight strawberries—low in calories and rich in antioxidants, strawberries help defend the immune system against free-radical damage and disease.
i). one quarter cup of blueberries—another source of antioxidants that help protect from cancer and age-related illnesses.
j). one-half banana (optional) which provides a source of potassium and flavor.
k). one packet or equivalent of a non-caloric or other sweetener as desired and needed to provide proper weight maintenance or balance.
l). as desired add ice cubes and blend until smooth and frothy.

This method and subsequent liquid formulation has been suggested for an active adult male. For smaller body frames half the mixture listed is recommended for consumption.

Many variations of the present invention will suggest themselves to those skilled in this art in view of the above-detailed description. For example, other cellulose gums and gels can be used, other or additional dietary fibrous materials such as can be utilized, aloe vera and other naturally earth grown legume powders, any flavored dry blend imaginable including a chocolate flavored dry blend, strawberry-flavored and vanilla flavored dry blends can be formulated. Various aerating agents such as Polysorbate 60 (Witco) or METHOCEL.RTM. (Dow) can be used. Furthermore, other gums and/or dietary fibers ay be used to vary the texture and mouth feel of the formulations. Additional protein sources such as albumin, wheat proteins, quinoa, millet, amaranth, and pea, and the like, may be used at desired levels to vary the essential amino acid content and total protein content and bioavailability. Various naturally occurring and manmade sweeteners such as sucrose, fructose, dextrose, sorbitol, aspartame and saccharin may be used depending on desired sweetness and caloric content. Other simple or complex carbohydrates may be incorporated or removed completely. Literally thousands of variations of the final liquid composition using the powdered formulation (s) described in the present invention are included within the spirit and scope of the present invention. All such obvious variations are within the scope of the appended claims.

What is claimed is;

1. A protein rich nutritional formulation for multiple dietary needs including optimal health and human immune system enhancement constituents comprising;
a protein blend comprising at least soy protein, whey protein egg white, casein, and non fat dry milk and optionally one or more of amaranth, quinoa, millet, rice, and/or other vegetable-based proteins combined with fructose, flaxseed meal powder, safflower oil, natural and artificial flavor, guar gum, cellulose gum, lecithin, sodium chloride, xanthan, acesulfame-K, sucralose, silicon dioxide, vitamin palmitate (vitamin A), ascorbic acid (vitamin D), dicalcium phosphate, cholecalciferol (vitamin D), vitamin E acetate, phytomenadione (vitamin K1), Vitamin B1, also known as and including thiamine or thiamine mononitrate, thiamin or aneurin, niacin or nicotinic acid, vitamin B2, also known as riboflavin, Vitamin B3 known as niacinamide, also known as niacin, or nicotinic acid, pantothenic acid or calcium pantothenate, also known as vitamin B5, vitamin B6 also known as pyridoxine HCl, vitamin B9, also known as folic acid or folate, vitamin B12, lecithin, cyanocobalamin, calcium pantothenate, potassium iodide, magnesium oxide, dimagnesium phosphate, zinc oxide, selenium amino acid chelate, copper gluconate, manganese sulfate, chromium amino acid chelate, molybdenum amino acid chelate, said formulation provided in either a dry powder or liquid form.

2. The protein rich nutritional formulation of claim 1, comprising a protein group including casein, whey, soy, egg white, and non fat dry milk, wherein said protein group is in the range of 10-50 grams by weight of a 60 gram composition of said formulation.

3. The protein rich nutritional formulation of claim 1, wherein said protein group is more preferably in the range of 25-40 grams by weight of a 60 gram composition of said formulation.

4. The protein rich nutritional formulation of claim 1, wherein said protein group is most preferably 34 grams by weight of a 60 gram composition of said formulation.

5. The protein rich nutritional formulation of claim 1, wherein either soluble fibers or insoluble fibers or both are optionally included within said formulation.

6. The protein rich nutritional formulation of claim 1, further including a flavor component imparting a characteristic taste to said formulation including but not limited to a group comprising water soluble natural or artificial extracts that include apple, banana, cherry, cinnamon, strawberry, cranberry, grape, honeydew, honey, kiwi, lemon, lime, orange, peach, peppermint, pineapple, raspberry, tangerine, watermelon, wild cherry, Dutch process cocoa, vanilla, and equivalents thereof being in the range of 0.5 to 10.0 grams by weight of a 60 gram composition of said formulation.

7. The protein rich nutritional formulation of claim 1, further including an emulsifier to ensure said nutritional formulation remains in suspension when combined with a liquid.

8. The protein rich nutritional formulation of claim 7, wherein said emulsifier is lecithin.

9. The protein rich nutritional formulation of claim 1, further including either one or more simple or complex carbohydrates or both or none such that said carbohydrate(s) comprise a portion of said formulation in the range of 0 to 30 grams by weight of a 60 gram composition of said formulation.

10. The protein rich nutritional formulation of claim 1, wherein said carbohydrate(s) comprise a portion of said formulation is more preferably in the range of 10 to 20 grams by weight of a 60 gram composition of said formulation.

11. The protein rich nutritional formulation of claim 1, wherein said carbohydrate(s) comprise a portion of said formulation is most preferably 14 grams by weight of a 60 gram composition of said formulation.

12. The protein rich nutritional formulation of claim 1, wherein said formulation has a caloric content of 240 calories, 45 of said calories attributed to fat in a 60 gram composition of said formulation.

13. The protein rich nutritional formulation of claim 1, wherein said formulation is in the form of a dry powder.

14. The protein rich nutritional formulation of claim 1, wherein said formulation is part of a liquid drink.

15. The protein rich nutritional formulation of claim 1, wherein said formulation is used as a portion of a food bar.

16. The protein rich nutritional formulation of claim 1, wherein said formulation is consumed before a meal is consumed.

17. The protein rich nutritional formulation of claim 1, wherein said formulation is consumed during the course of eating a meal.

18. The protein rich nutritional formulation of claim 1, wherein said formulation is consumed after the eating of a meal.

19. The protein rich nutritional formulation of claim 1, wherein said formulation is a food additive to other foods.

20. The protein rich nutritional formulation of claim 1, wherein said formulation is added to foods including but not limited to yogurt, jello, apple sauce, cottage cheese, cereal, bread, and food bars.

21. The protein rich nutritional formulation of claim 1, wherein said formulation is added to drinks including but not limited to apple juice, orange juice, grape juice, grapefruit juice, cranberry juice, coffee, tea, milk, milkshakes, broth, and soup consomme.

22. The protein rich nutritional formulation of claim 1, wherein said casein of said protein blend includes glycomacropeptides from an hydrosylate of said casein.

23. The protein rich nutritional formulation of claim 1, wherein an additional source of calcium includes at least one of the following forms of calcium; calcium acetate, calcium ascorbate, calcium asparate, calcium caseinate, calcium citrate, calcium gluconate, calcium lactate, calcium succinate and calcium tartrate.

24. A method for enhancing human immune system function, optimizing health, and achieving a proper weight of an individual by adding a protein rich nutritional formulation as provided in claim 1, wherein said nutritional formulation further comprises a drink by adding to a standard blender the following combination;
(a) a range of from 6 to 10 ounces of distilled water,
(b) two tablespoons of natural, non-pasteurized apple cider vinegar,
(c) optionally one tablespoon safflower oil,
(d) optionally one tablespoon flaxseed or fish oil which contains EPA (eicosapentaenoic acid) and DHA docosahexaenoic acid), both omega-3 fatty acids,
(e) at least 31 grams of said protein rich nutritional formulation of claim 1,
(f) optionally one teaspoon of glutamine powder,
(g) optionally one teaspoon of Methyl-Sulfonyl-Methane powder,
(h) six to eight strawberries,
(i) one quarter cup of blueberries,
(j) optionally one-half banana,
(k) a non-caloric or other sweetener as desired to improve taste,
(l) ice cubes and continue blending with said blender until said formulation drink is smooth and frothy.

25. A protein rich nutritional formulation for multiple dietary needs including optimal health and human immune system enhancement constituents comprising nutritionally effective amounts of proteins, carbohydrates, dietary fiber, vitamins and minerals, wherein each serving of 62 grams provides about 34 g of protein, about 14 g of carbohydrates and 240 calories after mixing with a liquid, said composition being capable of adaptation to mix with a liquid to provide a drinkable beverage.

26. A dry protein rich nutritional formulation for multiple dietary needs including optimal health and human immune system enhancement constituents which when mixed with an ingestible liquid and ingested, that can be used as a total or partial meal replacement without adverse gastrointestinal disturbances or other ill-health effects, comprising;
(a) a protein blend comprising protein concentrate including soy, whey, egg white, casein (in the form of calcium caseinate), and non fat dry milk, in an amount of about 1.0-95.0% by weight or at least 20 grams of protein in a 60 gram serving amount;
(b) said blend comprising a cellulose gum, including guar gum, safflower oil, xanthan gum (from algae) in an amount of about 1-95% by weight;
(c) said blend including a vitamin blend with at least vitamin A, vitamin D, vitamin K, all essential B vitamins including vitamin B1, also known as thiamine, thiamin or aneurin, niacin or nicotinic acid, vitamin B2, also known as riboflavin, vitamin B3 also known as niacinamide, niacin, or nicotinic acid, pantothenic acid or calcium pantothenate, also known as vitamin B5, vitamin B6, also known also as pyridoxine HCl, vitamin B9, also known as folic acid, vitamin B12 optionally in the form of cyanobalamin, as well as biotin, vitamin C, and vitamin E, and lecithin, all in sufficient amounts such that at least 5% of the Daily Value based on a 2000 calorie diet is achieved;
(d) a mineral blend in various forms that includes calcium, iodine, selenium, manganese, molybdenum, iron, phosphorus, magnesium, zinc, copper, and chromium all again in an amount of at least 5% of the Daily Value based on a 2000 calorie diet is achieved;
(e) a natural or an artificial sweetener or a mixture thereof in an amount of about 0.1-80.0% by weight;
(f) dietary fibers other than (b) in an amount of up to about 70% by weight including flax seed meal powder; and
(g) an effective amount of a flavoring agent, alone or in further combination with a coloring agent.

27. The formulation as defined in claim 26, wherein said protein blend further comprises optionally one or more of amaranth, quinoa, millet, rice, and/or other vegetable-based proteins.

28. The formulation as defined in claim 26, wherein said protein blend comprises at least 50% by weight of a total weight of said formulation.

29. The formulation as defined in claim 26, wherein said vitamin blend provides 35% of the Daily Value based on a 2000 calorie diet.

30. The formulation as defined in claim 26, wherein said mineral blend provides 35% of the Daily Value based on a 2000 calorie diet.

31. The formulation of claim 26, wherein either soluble fibers or insoluble fibers or both are optionally included within said formulation.

32. The protein rich nutritional formulation of claim 26, further including a flavor component imparting a characteristic taste to said formulation including but not limited to a group comprising water soluble natural or artificial extracts that include apple, banana, cherry, cinnamon, strawberry, cranberry, grape, honeydew, honey, kiwi, lemon, lime, orange, peach, peppermint, pineapple, raspberry, tangerine, watermelon, wild cherry, Dutch process cocoa, vanilla, and equivalents thereof being in the range of 0.5 to 10.0 grams by weight of a 60 gram composition of said formulation.

33. The protein rich nutritional formulation of claim 26, further including an emulsifier to ensure said nutritional formulation remains in suspension when combined with a liquid.

34. The protein rich nutritional formulation of claim 26, wherein said emulsifier is lecithin.

35. The protein rich nutritional formulation of claim 26, further including either one or more simple or complex carbohydrates or both or none such that said carbohydrate(s) comprise a portion of said formulation in the range of 0 to 30 grams by weight of a 60 gram composition of said formulation.

36. The protein rich nutritional formulation of claim 26, wherein said carbohydrate(s) comprise a portion of said formulation is more preferably in the range of 10 to 20 grams by weight of a 60 gram composition of said formulation.

37. The protein rich nutritional formulation of claim 26, wherein said carbohydrate(s) comprise a portion of said formulation is most preferably 14 grams by weight of a 60 gram composition of said formulation.

38. The protein rich nutritional formulation of claim 26, wherein said formulation has a caloric content of 240 calories, 45 of said calories attributed to fat in a 60 gram composition of said formulation.

39. The protein rich nutritional formulation of claim 26, wherein said formulation is in the form of a dry powder.

40. The protein rich nutritional formulation of claim 26, wherein said formulation is part of a liquid drink.

41. The protein rich nutritional formulation of claim 26, wherein said formulation is used as a portion of a food bar.

42. The protein rich nutritional formulation of claim 26, wherein said formulation is consumed before a meal is consumed.

43. The protein rich nutritional formulation of claim 26, wherein said formulation is consumed during the course of eating a meal.

44. The protein rich nutritional formulation of claim 26, wherein said formulation is consumed after the eating of a meal.

45. The protein rich nutritional formulation of claim 26, wherein said formulation is a food additive to other foods.

46. The protein rich nutritional formulation of claim 26, wherein said formulation is added to foods including but not limited to yogurt, jello, apple sauce, cottage cheese, cereal, bread, and food bars.

47. The protein rich nutritional formulation of claim 26, wherein said formulation is added to drinks including but not limited to apple juice, orange juice, grape juice, grapefruit juice, cranberry juice, coffee, tea, milk, milkshakes, broth, and soup consommé.

48. The protein rich nutritional formulation of claim 26, wherein said casein of said protein blend includes glycomacropeptides from an hydrosylate of said casein.

49. The protein rich nutritional formulation of claim 26, wherein an additional source of calcium includes at least one of the following forms of calcium; calcium acetate, calcium ascorbate, calcium asparate, calcium caseinate, calcium citrate, calcium gluconate, calcium lactate, calcium succinate and calcium tartrate.
